(19) United States
(12) Patent Application Publication
(10) Pub. No.: US 2021/0278702 A1
(43) Pub. Date: Sep. 9, 2021

(54) SPECTACLE LENS HAVING A DIFFRACTION STRUCTURE FOR LIGHT

(71) Applicant: Carl Zeiss AG, Oberkochen (DE)

(72) Inventors: Toufic Jabbour, Aalen (DE); Jannik Michael Trapp, Stutensee (DE); Wolfgang Singer, Aalen (DE); Manuel Decker, Jena (DE)

(21) Appl. No.: 17/145,472

(22) Filed: Jan. 11, 2021

Related U.S. Application Data
(63) Continuation of application No. PCT/EP2019/050730, filed on Jan. 13, 2019.

(30) Foreign Application Priority Data
Jul. 13, 2018 (DE) 10 2018 117 020.3

(51) Int. Cl. G02C 7/06; G02B 5/18

(52) U.S. Cl. CPC G02C 7/063; G02C 2202/20; G02B 5/1895

(57) ABSTRACT

A spectacle lens has a body containing at least one diffraction structure, which is made to extend in the body on a body surface. The diffraction structure is formed by a spatial modulation of the refractive index n(x, y) dependent on the location in the body surface. The spatial modulation of the refractive index n(x, y) in the body is continuous. The continuity of the spatial modulation of the refractive index n(x, y) in the body typically exists over a contiguous area B of the body surface, for the diameter D of which, defined as the supremum of the metric distance d(x, y) between two arbitrary points x, y arranged in the area of the body surface, with

D:=sup{d(x, y): x, y ∈ B},

the following applies:

D≥1 mm, preferably D≥10 mm, particularly preferably D≥20 mm.

### CROSS REFERENCE TO RELATED APPLICATIONS

This application is a continuation application of international patent application PCT/EP2019/050730, filed Jan. 13, 2019, designating the United States and claiming priority from German patent application DE 10 2018 117 020.3, filed Jul. 13. 2018, and the entire content of both applications is incorporated herein by reference.

### TECHNICAL FIELD

The disclosure relates to a spectacle lens with a body which contains at least one diffraction structure which is made to extend on a body surface and is formed by a spatial modulation of the refractive index n(x, y) dependent on the location in the body surface. The disclosure also extends to a method for determining the design of a spectacle lens and to a production method for a spectacle lens.

### BACKGROUND

A spectacle lens of the type mentioned at the beginning is known from WO 2015/177370 A1. Described there is a spectacle lens for an observer that has a body which is transparent or at least partially transparent to the light and has a phase object which directs the light incident at an angle of incidence α on the side facing away from the observer in a direction dependent on the wavelength λ of the light and on the angle of incidence α of the light. The phase object has a large number of locally different, discrete diffraction structures, which have in each case only a microscopic extent of for example 25 82 m×25 μm×25 μm and diffract the monochromatic light of the wavelength 380 nm≤λ≤800 nm with the diffraction efficiency η≥70% into one and the same order of diffraction |m|≥1 when the monochromatic light is incident on the side facing away from the observer at an angle of incidence α that lies within a 15° wide diffraction-structure-specific angle interval dependent on the wavelength of the light.

WO 99/34248 A1 specifies a spectacle lens with superposed holographic optical elements (HOE), which form a volume grating by means of which the light incident on the spectacle lens at a specific angle of incidence is diffracted, which leads to a deflection of the light incident on the spectacle lens for this angle of incidence.

WO 2014/064163 A1 describes a spectacle lens with a large number of light-diffracting zones that have different refractive powers.

Spectacle lenses in the form of refractive progressive lenses allow an observer suffering from a visual impairment to be able to view objects arranged at different distances with a more or less sharp visual impression, even if the eyes of this observer no longer have their accommodation capability, for example due to old age, or it is greatly limited.

Viewing zones are usually defined for the design of refractive progressive lenses. These viewing zones relate to regions of the surface of a progressive lens passed through by the viewing direction of an observer. If the observer looks through different viewing zones, this observer can see objects sharply at different object distances, even if their eyes have no accommodation capability or only limited accommodation capability.

Refractive progressive lenses generally have a distance zone which, when these lenses are used as intended, is passed through by the viewing direction of an eye of an observer looking into the distance. When looking through the distance zone, the objects arranged at infinity for the observer should be imaged in sharp focus on the retina. Moreover, refractive progressive lenses usually also have in addition to the distance zone a so-called near zone, which is spaced apart from the distance zone and, when the progressive lens is used as intended, is looked through by an observer with a maximum accommodation in order to observe objects arranged at a near distance (for example 40 cm) in front of the eyes.

Progressive lenses often have a so-called intermediate corridor between the near zone and the distance zone. This intermediate corridor connects the distance zone to the near zone. The refractive power of the progressive lens differs locally in the intermediate corridor. In order to provide a wide field of view to an observer with the progressive lens, it is in principle endeavored to make the intermediate corridor as wide as possible. However, the achievable width of the intermediate corridor is limited due to the differential geometric Minkwitz theorem. A consequence of this mathematical theorem is that, with increasing width of the intermediate corridor, i.e., an astigmatism caused by the Minkwitz theorem, an observer must accept non-correctable astigmatic imaging aberrations. The imaging quality of refractive progressive lenses and the possible extent of the near region zone and distance region zone of refractive progressive lenses a re therefore subject to fundamental limits.

### SUMMARY

It is an object of the disclosure to provide a spectacle lens for an observer, the optical effect of which for different viewing directions can be adapted with an improved imaging quality to the requirements of the observer, and to specify a method for determining the design of such a spectacle lens and a production method for such a spectacle lens.

In the present case, the optical effect of a spectacle lens is understood as meaning the property of deflecting light.

This object is achieved with the spectacle lens having at least one diffraction structure extending along a lens body surface, which is spatially modulated in dependence on a location on the body surface, a method for determining the design of such a spectacle lens and a production method for such a spectacle lens. Exemplary embodiments of the disclosure are specified below.

The disclosure is based on the idea that an observer who has no accommodation capability or only limited accommodation capability can visualize different distance ranges sharply if the rays of light projecting an image of the object area are deflected not by refraction but by diffraction.

In the present case, the diffraction of light is understood as meaning the physical phenomenon of the change in the phase of the light, caused by a phase object, on account of interactions between light and matter. Here, a phase object is a typically transparent object which influences or changes the phase of the light. A phase object needs a diffraction structure in order to diffract light at the phase object. Such a diffraction structure represents a regular, or else irregular, spatial modulation of the complex refractive index, for example in the form of a grating, which may extend in one dimension or in two dimensions (plane grating) or in three dimensions (volume grating).

A diffraction structure diffracts the light in a manner dependent on the angle of incidence of the light at which it is incident on the diffraction structure and in a manner dependent on the wavelength λ of the light. If light is diffracted at a diffraction structure, it can be deflected in one or more different, discrete directions due to constructive interference. In the present case, these directions are referred to as orders of diffraction and denoted, in line with general convention, by integers 0, ±1, ±2, ±3, . . . , with the central order being denoted by 0 and all further orders being numbered consecutively.

Accordingly, diffraction of the light into an order of diffraction |m|≥1 is understood as meaning the deflection of the light in the direction defined by the order of diffraction which arises due to constructive interference of phase-shifted light.

With a spectacle lens according to the disclosure, it is made possible in particular for an observer to sharply perceive objects arranged in different distance ranges even when the eyes have limited accommodation capability.

The angle to which a ray of light is diffracted by a diffraction structure and the angle at which a ray of light diffracted by the diffraction structure may be incident on the diffraction structure increase here with increasing absolute value of the order of diffraction. Here, a positive order of diffraction corresponds to a deflection angle for the light, related to the direction of incidence, which is positive; a negative order of diffraction corresponds to a negative deflection angle related to the direction of incidence of the light.

The ratio of the intensity I_{diffracted} of the light diffracted by a diffraction structure into an order of diffraction |m|≥1 to the intensity I_{incident} of the light incident on a boundary of the diffraction structure at a specific angle of incidence α′ is referred to in the present case as the diffraction efficiency η of the diffraction structure. The boundary of a diffraction structure may coincide with the surface of the transparent body of the spectacle lens, but this need not be the case. The boundary of a diffraction structure may also be situated within the transparent body.

The disclosure exploits the fact that the diffraction efficiency of a diffraction structure in a layer made of optically transparent material arranged on a carrier is dependent on:

the wavelength of the light (λ),

the refractive index (n) of the material from which the diffractive optical element is constructed,

the refractive index (n0) of the surrounding medium, the thickness (d) of the layer in which the refractive index is modulated,

the amplitude (Δn) of the modulation of the refractive index (n),

the period P of the modulation of the refractive index (n), and

the angle of incidence (α′, α″) of the light on a boundary of the diffraction structure.

The relation implicitly existing due to the dependencies between these variables means that it is possible to specify for a given wavelength the angle of incidence at which the layer in which the refractive index is modulated efficiently diffracts the light incident on it, i.e., in such a way that the diffraction efficiency η is greater than a specific, in principle selectable, threshold value.

In a way similar to a progressive lens, a spectacle lens according to the disclosure may have in particular a different optical effect, for different viewing directions. That is to say that, for a parallel bundle of light rays coming from infinity that passes through the side of the spectacle lens facing the object surface, the spectacle lens has, dependent on the area in which the bundle of light rays passes through the spectacle lens, a different refractive power, which may be caused just by the diffraction of the light in the phase object of the spectacle lens or by a combined diffraction and refraction of the light in the spectacle lens. A spectacle lens according to the disclosure for an observer may have a body which is transparent or at least partially transparent to the light and has a phase object which directs the light incident on a side of the spectacle lens facing away from the observer with respect to the surface normal at an angle of incidence α to a surface normal \vec{n} of the spectacle lens front surface in a direction dependent on the wavelength λ of the light and on the angle of incidence α of the light. The phase object in this case contains at least one diffraction structure which is made to extend in the body on a body surface and, when observing an object surface, can be passed through by a line of sight ray that corresponds to different viewing directions of an eye of the observer having a center of rotation of the eye and a pupil center and extends through the center of rotation of the eye and the pupil center as well as the point on the object surface. The diffraction structure is in this case formed by a spatial modulation of the refractive index n(x, y) dependent on the location in the surface passed through by the respective viewing direction. It should be noted that the body of the spectacle lens may have in particular a sandwich structure which contains a substrate and a film bonded to the substrate, for example a film based on light-sensitive photopolymers, in which the diffraction structure is formed. Such a film may for example only be bonded to the substrate after it has been exposed or be exposed in the substrate. The spatial modulation of the refractive index n(x, y) forming the at least one diffraction structure in the body is continuous. The continuity of the spatial modulation of the refractive index n(x, y) in the body is not only local, i.e., over an area of only a few μm in extent, but also exists on a macroscopic scale. The continuity of the spatial modulation of the refractive index n(x, y) in the body may in particular be global. With a global continuity of the spatial modulation of the refractive index n(x, y) in the body, the continuity of the spatial modulation of the refractive index n(x, y) in the body typically exists over a contignuous area B of the body surface, for the diameter D of which, defined as the supremum of the metric distance d(x, y) between two arbitrary points x, y arranged in the area of the body surface, with

D:=sup{d(x, y): x, y ∈ B},

the following applies:
D≥1 mm, typically D≥10 mm, particularly typically D≥20 mm.

This is so because, the larger the diameter D of the contiguous area B of the body surface is selected to be, the larger the field of view in which a continuous visual function without jumps is ensured for an observer by means of the spectacle lens in a field of view perceived by the observer.

The diffraction structure converts a spherical light wave which originates from a point on the object surface that can be observed by the observer from the respective viewing direction into a light wave, running along the viewing direction, which projects an image of the point on the object surface onto an image point in the eye of the observer lying in an image surface that is optically conjugate to the object surface. It should be noted that, even if the object surface is a plane, the optically conjugate image surface can deviate from a plane, taking into account the optics of the observer's eye. This is so because an eye capable of accommodation can compensate for changes in the object distance with different viewing directions. The optical effect of the spectacle lens according to the disclosure is thus determined in particular by the optical effect of the phase object. However, the optical effect of the spectacle lens does not necessarily have to be determined exclusively by the optical effect of the phase object. A spectacle lens according to the disclosure may for example also have an optical effect component determined by the refraction of light in its body which is transparent or at least partially transparent to the light.

A local wave vector \vec{k_{w}} of a light wave is understood in the present case as meaning a vector which is perpendicular to the wave front of a light wave and for the absolute value of which the following applies;

$$\vert \vec{{k}_{w}} \vert = \frac{2 π}{λ} ,$$

where λ is the wavelength of the light.

The at least one diffraction structure may be in particular a hologram of an object point and a reference wave with visible light. The hologram of an object point and a reference wave is understood in the present case, and as described in Bergmann Schäfer, Textbook of Experimental Physics, Volume 3, 10. edition, Verlag Walter de Gruyter Berlin N.Y. (2004) on pages 437 and 438 with reference to FIG. 3.104, to which reference is hereby made and with the disclosure content of the description of this matter fully included in the disclosure content of this application, as meaning an interference pattern generated by super posing a spherical light wave emitted from the object point and the reference wave.

The at least one diffraction structure may also be a hologram of at least a first reference wave W₁₁ and a second reference wave W₁₂. Since the first reference wave W₁₁ is in this case a spherical light wave emitted from the center of rotation of the eye of the observer or a spherical light wave emitted from a point near the point of rotation of the eye of the observer, it can be achieved that the at least one diffraction structure diffracts the light incident in the observer's eye at an angle to a line of sight ray with a high diffraction efficiency.

The hologram is typically formed as an optical grating that has a local grating period vector

\vec{Λ_{G38}}:=Λ₃₈ₓ\vec{eₓ}+Λ_{38y}\vec{e_{y}}+Λ_{38z}\vec{e_{z}}

and a local grating vector

$$\vec{{k}_{G 38}} := \frac{2 π}{{Λ}_{38 x}} {{e}_{x}}^{⟶} + \frac{2 π}{{Λ}_{38 y}} {{e}_{y}}^{⟶} + \frac{2 π}{{Λ}_{38 z}} {{e}_{z}}^{⟶}$$

with a grating vector amount,

$$i ) \vert \vec{{k}_{G 38}} \vert := \vert \frac{2 π}{{Λ}_{38 x}} {{e}_{x}}^{⟶} + \frac{2 π}{{Λ}_{38 y}} {{e}_{y}}^{⟶} + \frac{2 π}{{Λ}_{38 z}} {{e}_{z}}^{⟶} \vert$$

where \vec{eₓ}, \vec{e_{y}} and \vec{e_{z}} are mutually perpendicular unit vectors and Λₓ, Λ_{y} and Λ_{z} are the respective grating constant of the grating in the direction of the unit vectors.

For the grating vector amount |\vec{k_{G38}}| of the optical grating, the following typically applies: 2.0 μm≤2π/|\vec{k_{G38}}|≤2.4 μm.

This ensures that the optical grating of the hologram has a high diffraction efficiency η for the light in the visible spectral range with the wavelength 400 nm≤λ≤800 nm, which may then be above 80%.

The grating vector amount |\vec{k_{G38}}| local grating vector \vec{k_{G38}} may be globally constant m the grating of the hologram, that is to say constant in the contiguous area of the body surface. It should be noted however that, for the grating vector amount |\vec{k_{G38}}|, the following may also apply: |\vec{k_{G38}}|:=F₃₈(x, y), where F₃₈(x, y) is a scalar function dependent on the location in the body surface.

One idea of the disclosure is that the grating vector \vec{k_{G38}} has for at least one viewing direction of the observer in particular a grating vector amount that optimizes a diffraction efficiency η of the at least one diffraction structure. This is so because the inventors have found that, by optimizing a globally constant grating vector amount, a high broadband diffraction efficiency of the diffraction structure in the spectacle lens can be achieved, but that it is possible by optimizing the grating vector amount to also optimize imaging aberrations in the optical imaging of the spectacles with broadband high diffraction efficiency, that is to say to make the optical imaging aberrations of the spectacles, such as for example a spherical, astigmatic or chromatic aberration, so small that they are below a specified threshold value.

In particular, it is an idea of the disclosure that the grating vector \vec{k_{G38}} may have for at least one viewing direction of the observer a direction that optimizes an imaging aberration of the image point. The imaging aberration may in this case correspond to one imaging aberration or a number of imaging aberrations from the group comprising color defect, astigmatism, coma and defocus. That is to say that the aforementioned imaging aberrations are made so small by optimization that they are in each case below a specified threshold value. It is advantageous if the grating vector \vec{k_{G38}} has for at least one viewing direction of the observer a direction that optimizes a diameter of the image point, i.e., it is ensured that the diameter of the image point is below a specified value.

The grating vector \vec{k_{G38}} may however alternatively or additionally also have for at least one viewing direction of the observer a diffraction efficiency η of the at least one diffraction structure-optimizing direction, i.e., it is ensured that the following applies for the diffraction efficiency η of the at least one diffraction structure: η≥S, where S is a specified threshold value.

A spectacle lens according to the disclosure may have a body that is transparent or at least partially transparent to the light, wherein the diffraction structure is made to extend in the body on a body surface and, when observing the object surface, can be passed through by line of sight ray that corresponds to different viewing directions of an eye of an observer having a center of rotation of the eye and a pupil center and extends through the center of rotation of the eye and the pupil center as well as the point on the object surface.

Such a spectacle lens may have different optical effects for different viewing directions.

At each place that can be passed through by the line of sight ray on a side of the diffraction structure facing the observer, in this case the following advantageously applies for the wavefront vector \vec{k_{W11}} of the first reference wave W₁₁ and the wavefront vector \vec{k_{W12}} of the second reference wave W₁₂ and also the grating vector \vec{k_{G38}} of the hologram:

i) \vec{k_{W11}}=\vec{k_{W12}}−\vec{k_{G38}}

The grating vector \vec{k_{G38}} may have for at least one viewing direction of the observer a direction that optimizes an imaging aberration of the image point in the observer's eye. The imaging aberration may in this case correspond to one imaging aberration or a number of imaging aberrations from the group comprising color defect, astigmatism, coma etc. That is to say that the aforementioned imaging aberrations are minimized by optimization in such a way they are in each case below a specified threshold value.

The grating vector \vec{k_{G38}} may have for at least one viewing direction of the observer a direction that optimizes a diameter of the image point in the observer's eye. The grating vector \vec{k_{G38}} may alternatively or additionally also have for at least one viewing direction of the observer a diffraction efficiency η of the at least one diffraction structure-optimizing direction, i.e., it is ensured that the following applies for the diffraction efficiency η of the at least one diffraction structure: η≥S, where S is a specified threshold value.

Since the hologram is a hologram of two pairs of reference waves (W₁₁, W₁₂) or a number of pairs of reference waves, it can be achieved that light which falls into the eye of the observer at an angle to a line of sight ray can also be diffracted with a high diffraction efficiency.

It is advantageous if at least one further diffraction structure is provided, which diffracts light diffracted into a first order of diffraction O1 by the at least one diffraction structure into an order of diffraction O2, for which the following applies: |O1|=|O2| and sign(O1)=−sign(O2). In this way it can be achieved that the further diffraction structure at least partially compensates for an undesired dispersion of the first diffraction structure.

It should be noted that the body of the spectacle lens may have in particular a sandwich structure which contains a substrate and a film bonded to the substrate, in which the at least one further diffraction structure is formed.

The at least one further diffraction structure may in this case likewise be a hologram of at least one further first reference wave W₂₁ and a further second reference wave W₂₂, wherein the further first reference wave W₂₁ is the first reference wave W₁₁ diffracted by means of the at least one diffraction structure or the second reference wave W₁₂ diffracted by means of the at least one diffraction structure.

The hologram may be formed as an optical grating that has a local grating period vector

\vec{Λ_{G40}}:=Λ₄₀ₓ\vec{eₓ}+Λ_{40y}\vec{e_{y}}+Λ_{40z}\vec{e_{z}}

and a local grating vector

$$\vec{{k}_{G 40}} := \frac{2 π}{{Λ}_{40 x}} {{e}_{x}}^{⟶} + \frac{2 π}{{Λ}_{40 y}} {{e}_{y}}^{⟶} + \frac{2 π}{{Λ}_{40 z}} {{e}_{z}}^{⟶}$$

with grating vector amount

$$i ) \vert \vec{{k}_{G 40}} \vert := \vert \frac{2 π}{{Λ}_{40 x}} {{e}_{x}}^{⟶} + \frac{2 π}{{Λ}_{40 y}} {{e}_{y}}^{⟶} + \frac{2 π}{{Λ}_{40 z}} {{e}_{z}}^{⟶} \vert .$$

For the grating vector amount |\vec{k_{G40}}| of the optical grating of the hologram of the further diffraction structure, the following typically applies: 2.0 μm≤2π/|\vec{k_{G38}}|≤2.8 μm. The grating vector amount |\vec{k_{G40}}| may be globally constant in the grating of the hologram. It should be noted however that, for the grating vector amount |\vec{k_{G40}}|, the following may also apply: |\vec{k_{G40}}|:=F(x, y), where F(x, y) is a scalar function dependent on the location in the body surface.

One idea of the disclosure is that the grating vector \vec{k_{G40}} may have for at least one viewing direction of the observer a grating vector amount that optimizes a diffraction efficiency η of the at least one diffraction structure.

In particular, it is an idea of the disclosure that the grating vector \vec{k_{G40}} may have for at least one viewing direction of the observer a direction that optimizes an imaging aberration of the image point. The imaging aberration may in this case correspond to one imaging aberration or a number of imaging aberrations from the group comprising color defect, astigmatism, coma and defocus. Alternatively or additionally, the grating vector \vec{k_{G40}} may have for at least one viewing direction of the observer a direction that optimizes a diameter of the image point.

The grating vector \vec{k_{G40}} may also have for at least one viewing direction of the observer a direction that optimizes a diffraction efficiency η of the at least one diffraction structure.

It is advantageous if, at each place that can be passed through by the line of sight ray on a side of the further diffraction structure facing the observer, in this case the following applies for the wavefront vector \vec{k_{W21}} of the further first reference wave W₂₁ and the wavefront vector \vec{k_{W22}} of the further second reference wave W₂₂ and also the grating vector \vec{k_{G40}} of the hologram.

\vec{k_{W21}}=\vec{k_{W22}}−\vec{k_{G40}}.

It should be noted that the grating vector \vec{k_{G40}} for at least one viewing direction of the observer may also have a direction that optimizes a diffraction efficiency η of the at least one diffraction structure. Alternatively or additionally, it is possible for the hologram to be a hologram of two pairs of reference waves (W₂₁, W₂₂) or a number of pairs of reference waves (W₂₁, W₂₂; W₂₃, W₂₄; . . . ).

The diffraction structures may be attached to a flattest surface on or in a spectacle lens according to the disclosure. For lenses with a negative effect this may be for example the side of the spectacle lens facing away from the eye of an observer.

It should be noted that the diffraction structures in a spectacle lens according to the disclosure may be formed in laminated-on films with a holographic material, such as for example Bayfol HX from Covestro AG, which are cemented to the glass body of the spectacle lens.

It should also be noted that, in the case of a spectacle lens according to the disclosure, for aesthetic reasons free-form surfaces are typically arranged on the side of the spectacle lens facing away from the eye of an observer.

This is so because the inventors have recognized in particular that a long path through glass between diffraction structures and a free-form surface has a positive influence on the reduction in the variance of the spherical effect and the astigmatism.

The at least one diffraction structure in a spectacle lens according to the disclosure makes it possible to reduce the center thickness in spectacle lenses with a high positive spherical effect and the edge thickness in spectacle lenses with a high negative spherical effect. In addition, the disclosure also allows the mechanical stability of the spectacle lenses to be improved due to the diffraction structures introduced in them. Diffraction structures formed as films and/or layer systems allow in particular protection from splintering.

In a spectacle lens according to the disclosure, the body may have a phase object which contains the at least one diffraction structure. The phase object and the body in this case directs the light incident on a side of the spectacle lens facing away from the observer with respect to the surface normal at an angle of incidence α₁ to a surface normal of the spectacle lens front surface from a point on an object surface in a direction dependent on the wavelength λ of the light and on the angle of incidence of the light. For the light incident on a side of the spectacle lens facing away from the observer with respect to the surface normal at the angle of incidence α₁ to the surface normal of the spectacle lens front surface from the point on the object surface, the body is a refractive body with a refractive dispersion D_{ref.1} with

$${D}_{ref .1} := \frac{\partial {α}_{2}}{\partial λ} = \frac{\partial }{\partial λ} asin ( \frac{{B}_{1} ( λ ) sin {α}_{1}}{{B}_{2} ( λ )} ) .$$

For the light exiting from the point on the object surface on a side of the spectacle lens facing the observer with respect to the surface normal at the exit angle α₆, the body is a refractive body with a refractive dispersion D_{ref.2} with

$${D}_{diff .2} = \frac{\partial {α}_{3}}{\partial λ} = \frac{m}{{Λ}_{proj .40} cos {α}_{3}} .$$

n₁(λ) here is the refractive index, generally dependent on the wavelength λ, of an optical medium for light arranged between the object surface and the body.

n₂(λ) is the refractive index, generally dependent on the wavelength λ, of the body for the light.

n₃(λ) is the refractive index, generally dependent on the wavelength λ, of an optical medium for the light arranged between the pupil and the body.

The diffraction structure has in this case for the light incident on a side of the spectacle lens facing away from the observer with respect to the surface normal at the angle of incidence α₁ to the surface normal of the spectacle lens front surface from the point on the object surface a diffractive dispersion D_{diff.1} that compensates at least partially for the refractive dispersionD_{ref.}:=D_{ref.1}+D_{ref.2} of the body with

$${D}_{diff .1} = \frac{\partial {α}_{4}}{\partial λ} = \frac{m}{{Λ}_{proj .38} cos {α}_{4}} .$$

Here, α₄ is a deflection angle, related to a surface normal at a place of the body surface on which the diffraction structure is made to extend that is passed through light incident on the spectacle lens front surface at the angle of incidence α₁ to the surface normal of the spectacle lens front surface front the point on the object surface, for the light incident on the spectacle lens front surface at the angle of incidence α₁ to the surface normal of the spectacle lens front surface from the point on the object surface.

The diffraction structure is a hologram of at least a first reference wave W₁₁ and a second reference wave W₁₂, which is formed as an optical grating that has a local grating period vector

\vec{Λ_{G38}}:=Λ₃₈ₓ\vec{eₓ}+Λ_{38y}\vec{e_{y}}+Λ_{38z}\vec{e_{z}}

and a local grating vector

$$\vec{{k}_{G 38}} := \frac{2 π}{{Λ}_{38 x}} {{e}_{x}}^{⟶} + \frac{2 π}{{Λ}_{38 y}} {{e}_{y}}^{⟶} + \frac{2 π}{{Λ}_{38 z}} {{e}_{z}}^{⟶}$$

with a grating vector amount

$$\vert \vec{{k}_{G 38}} \vert := \vert \frac{2 π}{{Λ}_{38 x}} {{e}_{x}}^{⟶} + \frac{2 π}{{Λ}_{38 y}} {{e}_{y}}^{⟶} + \frac{2 π}{{Λ}_{38 z}} {{e}_{z}}^{⟶} \vert .$$

Λ_{proj.38} is in this case the grating period of the projection of the grating vector.

$$\vec{{k}_{G 38}} := \frac{2 π}{{Λ}_{38 x}} {{e}_{x}}^{⟶} + \frac{2 π}{{Λ}_{38 y}} {{e}_{y}}^{⟶} + \frac{2 π}{{Λ}_{38 z}} {{e}_{z}}^{⟶}$$

onto the body surface

$${Λ}_{proj .38} := \frac{2 π}{\vert \frac{2 π}{{Λ}_{38 x}} {{e}_{x}}^{⟶} + \frac{2 π}{{Λ}_{38 y}} {{e}_{y}}^{⟶} \vert} .$$

The following may apply in particular to the spectacle lens:

i) sign(D_{ref.1}+D_{ref.2})=−sign(D_{diff.1})

A spectacle lens according to the disclosure may contain at least one further diffraction structure, which diffracts light diffracted into a first order of diffraction O1 by the at least one diffraction structure into an order of diffraction O2, for which the following applies: |O1|=|O2| and sign(O1)=−sign(O2).

The at least one further diffraction structure is in this case made to extend on a further body surface, which may coincide with the first body surface and is formed by a spatial modulation of the refractive index n(x, y) dependent on the location in the body surface.

The at least one further diffraction structure is in this case a hologram of at least one further first reference wave W₂₁ and a further second reference wave W₂₂, wherein the further first reference wave W₂₁ is the first reference wave W₁₁ diffracted by means of the at least one diffraction structure or the second reference wave W₁₂ diffracted by means of the at least one diffraction structure.

The hologram of the further diffraction structure is in this case formed as a further optical grating that has a local grating period vector

\vec{Λ_{G40}}:=Λ₄₀ₓ\vec{eₓ}+Λ_{40y}\vec{e_{y}}+Λ_{40z}\vec{e_{z}}

and a local grating vector

$$\vec{{k}_{G 40}} := \frac{2 π}{{Λ}_{40 x}} {{e}_{x}}^{⟶} + \frac{2 π}{{Λ}_{40 y}} {{e}_{y}}^{⟶} + \frac{2 π}{{Λ}_{40 z}} {{e}_{z}}^{⟶}$$

with a grating vector amount

$$\vert \vec{{k}_{G 4 \; 0}} \vert := \vert \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}} \vert .$$

For the light incident on a side of the spectacle lens facing away from the observer with respect to the surface normal at the angle of incidence α₁ to the surface normal of the spectacle lens front surface from the point on the object surface and then refracted to the angle α₂ with respect to the surface normal, the at least one further diffraction structure has a diffractive dispersion D_{diff.2} with

$${D}_{diff .2} := \frac{\partial {α}_{3}}{\partial λ} = \frac{m}{{Λ}_{proj , 40} cos {α}_{3}} ,$$

where Λ_{proj.40} is the grating period of the projection of the grating vector of the further optical grating

$$\vec{{k}_{G 4 \; 0}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

onto the further body surface with

$${Λ}_{proj .40} := \frac{2 π}{\vert \frac{2 π}{{Λ}_{40 x}} \vec{{e}_{x}} + \frac{2 π}{{Λ}_{40 y}} \vec{{e}_{y}} \vert} .$$

In this case, α₃ is a deflection angle, related to a surface normal at a place of the further body surface on which the further diffraction structure is made to extend that is passed through by the light incident on the spectacle lens front surface at the angle of incidence α₁ to the surface normal of the spectacle lens front surface from the point on the object surface, for the light incident on the spectacle lens front surface at the angle of incidence α₁ to the surface normal of the spectacle lens front surface from the point on the object surface.

In this way, a spectacle lens can be provided in which the diffractive properties of diffraction structures and the refractive properties of the body of the spectacle lens are matched to one another in such a way that astigmatic imaging aberrations of the body of the spectacle lens caused by the refraction of the light are small, i.e., are below a specified threshold value, and chromatic aberrations caused by diffraction structures are small, i.e., are below a specified threshold value S.

It is advantageous if the following applies for the refractive dispersions D_{ref.1}, D_{ref.2} of the body and the diffractive dispersions D_{diff.1}, D_{diff.2} of the diffraction structures of the spectacle lens.

sign(D_{ref.1}+D_{ref.2})=−sign(D_{diff.1}+D_{diff.2})

In this way it can be achieved that the refractive and dispersive dispersion for the light which passes through the spectacle lens is at least partially eliminated.

In particular, it is advantageous if the refractive dispersions D_{ref.1}, D_{ref.2} of the body and the diffractive dispersions D_{diff.1}, D_{diff.2} of the diffraction structures of the spectacle lens satisfy the following relationship:
i) |D_{ref.1}+D_{ref.1}+D_{diff.1}+D_{diff.1}|≤S,
   with S=0.72 cm/m, typically S=0.36 cm/m, particularly typically S=0.12 cm/m.

If the following applies for the refractive dispersions D_{ref.1}, D_{ref.2} of the body and the diffractive dispersions D_{diff.1}, D_{diff.2} of the diffraction structures of the spectacle lens: S≤0.12 cm/m, then a color defect for the imaging produced in a human eye using the spectacle lens is below the perception threshold.

If on the other hand the following applies for the refractive dispersions D_{ref.1}, D_{ref.2} of the body and the diffractive dispersions D_{diff.1}, D_{diff.2} of the diffraction structures of the spectacle lens: S≤0.36 cm/m or S≤0.72 cm/m, then a color defect is generally not a problem for the imaging produced in a human eye using the spectacle lens in everyday use.

One idea of the disclosure is, in particular, to use a cost function to optimize the shape of aspheres or free-form surfaces and diffraction structures in a spectacle lens in such a way that imaging aberrations, in particular chromatic aberrations, are small and the lens thickness of the spectacle lens, for lenses with positive refractive power the center thickness, for lenses with negative refractive power the edge thickness, is as small as possible.

For this purpose, the disclosure proposes an optimization method which may in particular be multi-stage and in which the target values of the optimization are readjusted several times. By optimizing a cost function, a good compromise can be found for diffraction structures and spectacle lens parameters such as for example the variance of the spherical effect, the astigmatism, lateral chromatic aberration and/or lens thickness, in particular center thickness or edge thickness.

In particular, the disclosure proposes that the grating vector \vec{k_{G38}} of the diffraction structure and the grating vector \vec{k_{G40}} of the further diffraction structure may have for at least one viewing direction of the observer grating vector amounts |\vec{k_{G38}}|, |\vec{k_{G40}}| that optimize a cost function K, where the cost function K contains a cost function term Kᵢ with:

Kᵢ:=K_{iGP1}+K_{iGP2}+K_{iGP2}+K_{iSPH}+K_{iFF}

with

$${K}_{iGP 1} := {a}_{1} ( \vert \frac{2 π}{\vert \vec{{k}_{G 38}} \vert} - 2.4 μm \vert - 0.4 μm )$$

at the location passed through by the viewing direction on the body surface on which the diffraction structure is made to extend,

with

$${K}_{iGP 2} := {a}_{2} ( \vert \frac{2 π}{\vert \vec{{k}_{G 40}} \vert} - 2.4 μm \vert - 0.4 μm )$$

at the location passed through by the viewing direction on the further body surface on which the further diffraction structure is made to extend.

with K_{iSPH}:=a₃(SPHᵢₛₜ−SPHₛₒₗₗ) as a spherical aberration of the point on the object surface,

with K_{iAST}:=a₄(ASTᵢₛₜ−ASTₛₒₗₗ) as an astigmatic aberration of the point on the object surface,

with K_{iFF}=a₅(FF_{iST}−FFₛₒₗₗ) as a chromatic aberration of the point on the object surface,

where the coefficients aₓ can be freely selected with x=1, 2, 3, 4, 5.

In the case of the spectacle lens, it may be provided that the grating vector \vec{k_{G38}} of the diffraction structure and the grating vector \vec{k_{G40}} of the further diffraction structure have for a large number of viewing directions i of the observer grating vector amounts |\vec{k_{G38}}|, |\vec{k_{G40}}| that optimize a cost function K, where the cost function K contains a cost function term K with:

\tilde{K}:=ΣᵢKi

where

Kᵢ:=K_{iGP1}+K_{iGP2}+K_{iGP2}+K_{iSPH}+K_{iPF}

with

$${K}_{iGP 1} := {a}_{1} ( \vert \frac{2 π}{\vert \vec{{k}_{G 38}} \vert} - 2.4 μm \vert - 0.4 μm )$$

at the location passed through by the viewing direction i on the body surface on which the diffraction structure is made to extend,

with

$${K}_{iGP 2} := {a}_{2} ( \vert \frac{2 π}{\vert \vec{{k}_{G 40}} \vert} - 2.4 μm \vert - 0.4 μm )$$

at the location passed through by the viewing direction i on the further body surface on which the further diffraction structure is made to extend.

with K_{iSPH}:=aᵢ₃(SPHᵢₛₜ−SPHₛₒₗₗ) as a spherical aberration of the point on the object surface,

with K_{iAST}:=aᵢ₄(ASTᵢₛₜ−ASTₛₒₗₗ) as an astigmatic aberration of the point on the object surface,

with K_{iFF}=aᵢ₅(FFᵢₛₜ−FFₛₒₗₗ) as a chromatic aberration of the point on the object surface,

where the coefficients aᵢₓ can be freely selected with x=1, 2, 3, 4, 5.

The spectacle lens typically has a geometry of the body, in particular a center thickness of the body and/or a front radius of the body and/or a back radius of the body, values optimizing the cost function K.

In this way it can be achieved that for example spherical imaging aberrations are minimized in the spectacle lens and/or that the spectacle lens has a specified mechanical stability and/or that the geometry of the spectacle lens meets predefined shape requirements.

The geometry of the body may in this case have coefficients describing an aspherical shape or a free-surface shape of the spectacle lens front surface and/or the spectacle lens rear surface.

The spectacle lens specified above may have a positive refractive power, where the cost function K contains a cost function term K_{Rand} with: K_{Rand}:=aₓ(RDᵢₛₜ−Rₛₒₗₗ), where RDᵢₛₜ is an actual value for the center thickness of the spectacle lens and where RDₛₒₗₗ is a target value for the center thickness of the spectacle lens.

The spectacle lens specified above may however also have a negative refractive power, where the cost function K here then contains a cost function term K_{Rand} with: K_{Rand}:=aₓ(RDᵢₛₜ−RDₛₒₗₗ), where RDᵢₛₜ is an actual value for the edge thickness of the spectacle lens and where RDₛₒₗₗ is a target value for the edge thickness of the spectacle lens.

In a method according to the disclosure for determining the design of a spectacle lens, a geometry and an object surface and also an optical transfer function is specified for the spectacle lens. A phase object which directs the light incident on a side of the spectacle lens facing away from the observer at an angle of incidence α to a surface normal \vec{n} of the spectacle lens front surface in a direction dependent on the wavelength λ of the light and on the angle of incidence α of the light, is then calculated for the specified optical transfer function and the specified geometry. The phase object in this case contains at least one diffraction structure which is made to extend in the body on a body surface and, when observing an object surface, can be passed through by a line of sight ray that corresponds to a viewing direction of an eye of the observer having a center of rotation of the eye and a pupil center and extends through the center of rotation of the eye and the pupil center as well as the point on the object surface. The diffraction structure is formed by a spatial modulation of the refractive index n(x, y) that is dependent on the location (x, y) in the body surface passed through by the viewing direction.

The spatial modulation of the refractive index n(x, y) forming the at least one diffraction structure is continuous in the area of the body that can be passed through by a viewing direction. The continuity of the spatial modulation of the refractive index n(x, y) in the body is not only local but also exists on a macroscopic scale. The continuity of the spatial modulation of the refractive index n(x, y) in the body may in particular be global. For this, the continuity of the spatial modulation of the refractive index n(x, y) in the body typically exists over a contiguous area B of the body surface, for the diameter D of which, defined as the supremum of the metric distance d(x, y) between two arbitrary points x, y arranged in the area of the body surface, with

D:=sup{d(x, y): x, y ∈ B},

the following applies:
D≥1 mm, typically D≥10 mm, particularly typically D≥20 mm.

The diffraction structure converts a spherical light wave which originates from a point on the object surface that is passed through by the viewing direction into a light wave, running along the viewing direction, which projects an image of the point on the object surface onto an image point in the eye of the observer lying in an image surface that is optically conjugate to the object surface.

The at least one diffraction structure is a hologram of at least a first reference wave W₁₁ and a second reference wave W₁₂, wherein the hologram is formed as an optical grating that has a local grating period vector

\vec{Λ_{G40}}:=Λ₄₀ₓ\vec{eₓ}+Λ_{40y}\vec{e_{y}}+Λ_{40z}\vec{e_{z}}

and a local grating vector

$$\vec{{k}_{G 4 \; 0}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

with a grating vector amount

$$\vec{{k}_{G 4 \; 0}} := \vert \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}} \vert .$$

For the grating vector amount |\vec{k_{G40}}| of the optical grating, the following typically applies here: 2.0 μm≥2π/|\vec{k_{G38}}|≤2.8 μm. It should be noted that the grating vector amount |\vec{k_{G40}}| of the optical grating may be globally constant. It should however also be noted that, for the grating vector amount, the following applies:

|\vec{k_{G40}}|:=F₄₀(x, y),

where F₄₀(x, y) is a scalar function dependent on the location in the body surface.

It is advantageous if the grating vector amount |\vec{k_{G40}}| of the grating vector \vec{k_{G40}} is optimized for at least one viewing direction of the observer in order to optimize an imaging aberration of the image point in the eye of the observer.

It should be noted that the imaging aberration may correspond to one imaging aberration or a number of imaging aberrations from the group comprising color defect, astigmatism, coma. It should also be noted that the grating vector amount |\vec{k_{G40}}| of the grating vector \vec{k_{G40}} may be optimized for at least one viewing direction of the observer in order to minimize a diameter of the image point in the eye of the observer.

The grating vector amount |\vec{k_{G40}}| of the grating vector \vec{k_{G40}} may also be optimized for at least one viewing direction of the observer to the effect that a diffraction efficiency η of the at least one diffraction structure is maximized.

The direction of the grating vector \vec{k_{G40}} is typically optimized for at least one viewing direction of the observer in order to optimize an imaging aberration of the image point in the eye of the observer. The imaging aberration may in this case correspond to one imaging aberration or a number of imaging aberrations from the group comprising color defect, astigmatism, coma or defocus.

The grating vector \vec{k_{G40}} may alternatively or additionally also be optimized for at least one viewing direction of the observer in order to minimize a diameter of the image point in the eye of the observer.

It should be noted that the grating vector \vec{k_{G40}} may also be optimized for at least one viewing direction of the observer in order to maximize a diffraction efficiency η of the at least one diffraction structure.

It should also be noted that the body may have a phase object which contains the at least one diffraction structure, wherein the phase object and the body directs the light incident on a side of the spectacle lens facing away from the observer with respect to the surface normal at an angle of incidence α₁ to a surface normal of the spectacle lens front surface from a point on an object surface in a direction dependent on the wavelength λ of the light and on the angle of incidence α₁ of the light.

For the light incident on a side of the spectacle lens facing away from the observer with respect to the surface normal at the angle of incidence α₁ to the surface normal of the spectacle lens front surface from the point on the object surface, the body is in this case a refractive body with a refractive dispersion D_{ref.1} with

$${D}_{ref .1} := \frac{\partial {α}_{2}}{\partial λ} = \frac{\partial }{\partial λ} a sin ( \frac{{n}_{1} ( λ ) sin {α}_{1}}{{n}_{2} ( λ )} ) ,$$

For the light exiting from the point on the object surface on a side of the spectacle lens facing the observer with respect to the surface normal at the exit angle α₆, the body is a refractive body with a refractive dispersion D_{ref.2} with

$${D}_{ref .2} := \frac{\partial {α}_{6}}{\partial λ} = \frac{\partial }{\partial λ} a sin ( \frac{{n}_{2} ( λ ) sin {α}_{6}}{{n}_{3} ( λ )} ) .$$

In this case, n₁(λ) is the refractive index, generally dependent on the wavelength λ, of an optical medium for the light arranged between the object surface and the body.

n₂(λ) is the refractive index, generally dependent on the wavelength λ, of the body, for the light,

and n₃(λ) is the refractive index, generally dependent on the wavelength λ, of an optical medium for the light arranged between the pupil and the body.

The diffraction structure has in this case, for the light incident on a side of the spectacle lens facing away from the observer with respect to the surface normal at the angle of incidence α₁ to the surface normal of the spectacle lens front surface from the point on the object surface, a diffractive dispersion D_{diff.1} compensates at least partially for the refractive dispersionD_{ref.}:=D_{ref.1}+D_{ref.2} of the body with

$${D}_{diff .1} := \frac{\partial {α}_{4}}{\partial λ} = \frac{m}{{Λ}_{proj .38} cos {α}_{4}} .$$

In this case, α₄ is a deflection angle, related to a surface normal at a place of the body surface on which the diffraction structure is made to extend that is passed through by the light incident on the spectacle lens front surface at the angle of incidence λ₁ to the surface normal of the spectacle lens front surface from the point on the object surface, for the light incident on the spectacle lens front surface at the angle of incidence to the surface normal of the spectacle lens front surface from the point on the object surface.

The diffraction structure is a hologram of at least a first reference wave W₁₁ and a second reference wave W₁₂, which is formed as an optical grating that has a local grating period vector

\vec{Λ_{G38}}:=Λ₃₈ₓ\vec{eₓ}+Λ_{38y}\vec{e_{y}}+Λ_{38z}\vec{e_{z}}

and a local grating vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

with grating vector amount

$$\vert \vec{{k}_{G 38}} \vert := \vert \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}} \vert .$$

Λ_{proj.38} is the grating period of the projection of the grating vector

$$\vec{{k}_{G 38}} := \frac{2 }{{Λ}_{38 x}} \vec{{e}_{x}} + \frac{2 }{{Λ}_{38 y}} \vec{{e}_{y}} + \frac{2 }{{Λ}_{38 z}} \vec{{e}_{z}}$$

onto the body surface with

$${Λ}_{proj .38} := \frac{2 }{\vert \frac{2 }{{Λ}_{38 x}} \vec{{e}_{x}} + \frac{2 }{{Λ}_{38 y}} \vec{{e}_{y}} \vert} .$$

It is advantageous if the following relationship applies for the refractive dispersions D_{ref.2},D_{ref.2} and the diffractive dispersion D_{ref.2};

sign(D_{ref.1}+D_{ref.2})=−sign(D_{diff.1})

In the method for determining the design of a spectacle lens, it may be provided that at least one further diffraction structure, which diffracts light diffracted into a first order of diffraction O1 by the at least one diffraction structure into an order of diffraction O2, for which the following applies: |O1=|O2| and sign(O1)=−sign(O2),

wherein the at least one further diffraction structure is made to extend on a further body surface, which may coincide with the first body surface and is formed by a spatial modulation of the refractive index n(x, y) dependent on the location in the body surface,

wherein the at least one further diffraction structure is a hologram of at least one further first reference wave W₂₁ and a further second reference wave W₂₂, wherein the further first reference wave W₂₁ is the first reference wave W₁₁ diffracted by means of the at least one diffraction structure or the second reference wave W₁₂ diffracted by means of the at least one diffraction structure,

wherein the hologram of the further diffraction structure is formed as a further optical grating that has a local grating period vector

\vec{Λ_{G40}}:=Λ₄₀ₓ\vec{eₓ}+Λ_{40y}\vec{e_{y}}+Λ_{40z}\vec{e_{z}}

and a local grating vector

$$\vec{{k}_{G 40}} := \frac{2 }{{Λ}_{40 x}} \vec{{e}_{x}} + \frac{2 }{{Λ}_{40 y}} \vec{{e}_{y}} + \frac{2 }{{Λ}_{40 z}} \vec{{e}_{z}}$$

with a grating vector amount

$$\vert \vec{{k}_{G 40}} \vert := \vert \frac{2 }{{Λ}_{40 x}} {e}_{x}^{′} + \frac{2 }{{Λ}_{40 y}} {e}_{y}^{′} + \frac{2 }{{Λ}_{40 z}} {e}_{z}^{′} \vert$$

hat,

wherein, for the light incident on a side of the spectacle lens facing away from the observer with respect to the surface normal at the angle of incidence α₁ to the surface normal of the spectacle lens front surface from the point on the object surface and then refracted to the angle α₂ with respect to the surface normal, the at least one further diffraction structure has a diffractive dispersion D_{diff.2} with

$${D}_{diff .2} := \frac{\partial {α}_{3}}{\partial λ} = \frac{m}{{Λ}_{proj .40} {cos α}_{3}} ,$$

where Λ_{proj.40} is grating period of the projection of the grating vector of the further optical grating

$$\vec{{k}_{G 40}} := \frac{2 }{{Λ}_{40 x}} \vec{{e}_{x}} + \frac{2 }{{Λ}_{40 y}} \vec{{e}_{y}} + \frac{2 }{{Λ}_{40 z}} \vec{{e}_{z}}$$

onto the further body surface with

$${Λ}_{proj .40} := \frac{2 }{\vert \frac{2 }{{Λ}_{40 x}} \vec{{e}_{x}} + \frac{2 }{{Λ}_{40 y}} \vec{{e}_{y}} \vert}$$

and wherein α₃ is a deflection angle, related to a surface normal at a place of the further body surface on which the further diffraction structure is made to extend that is passed through by the light incident on the spectacle lens front surface at the angle of incidence α₁ to the surface normal of the spectacle lens front surface from the point on the object surface, for the light incident on the spectacle lens front surface at the angle of incidence α₁ to the surface normal of the spectacle lens front surface from the point on the object surface.

The following typically applies here with respect to the method:

sign(D_{ref.1}+D_{ref.2})=−sign(D_{diff.1}+D_{diff.2})

It is also advantageous if the following applies with respect to the method: |i) D_{ref.1}+D_{ref.1}+D_{diff.1}+D_{diff.1}|≤S,

with S=0.72 cm/m, typically S=0.36 cm/m, particularly typically S=0.12 cm/m.

The grating vector \vec{k_{G38}} of the diffraction structure and the grating vector \vec{k_{G40}} of the further diffraction structure for at least one viewing direction of the observer may have grating vector amounts |\vec{k_{G38}}|, |\vec{k_{G40}}| which are determined by optimizing a cost function K, where the cost function K contains a cost function term Kᵢ with:

Kᵢ:=K_{iGP1}+K_{iGP2}+K_{iGP2}+K_{iSPH}+K_{iFF}

with

$${K}_{iGP 1} := {a}_{1} ( \vert \frac{2 }{\vert \vec{{k}_{G 38}} \vert} - 2.4 µm \vert - 0.4 µm )$$

at the location passed through by the viewing direction on the body surface on which the diffraction structure is made to extend,

with

$${K}_{iGP 2} := {a}_{2} ( \vert \frac{2 }{\vert \vec{{k}_{G 40}} \vert} - 2.4 µm \vert - 0.4 µm )$$

at the location passed through by the viewing direction on the further body surface on which the further diffraction structure is made to extend,

with K_{iSPH}:=a₂(SPHᵢₛₜ−SPHₛₒₗₗ) as a spherical aberration of the point on the object surface.

with K_{iAST}:=a₄(ASTᵢₛₜ−ASTₛₒₗₗ) as an astigmatic aberration of Hie point on the object surface,

with K_{IFF}=a₅(FFᵢₛₜ−FFₛₒₗₗ) as a chromatic aberration of the point on the object surface,

where the coefficients aₓ can be freely selected with x=1, 2, 3, 4, 5.

In the method, the grating vector \vec{k_{G38}} of the diffraction structure and the grating vector \vec{k_{G40}} of the further diffraction structure have for a large number of viewing directions i of the observer grating vector amounts |\vec{k_{G38}}|, |\vec{k_{G40}}| which are determined by optimizing a cost function K, where the cost function K contains a cost function term K\tilde{K} with:

\tilde{K}:=ΣᵢKi

where

Kᵢ:=K_{iGP1}+K_{iGP2}+K_{iGP2}+K_{iSPH}+K_{iFF}

with

$${K}_{iGP 1} := {a}_{1} ( \vert \frac{2 }{\vert \vec{{k}_{G 38}} \vert} - 2.4 µm \vert - 0.4 µm )$$

at the location passed through by the viewing direction i on the body surface on which the diffraction structure is made to extend,

with

$${K}_{iGP 2} := {a}_{2} ( \vert \frac{2 }{\vert \vec{{k}_{G 40}} \vert} - 2.4 µm \vert - 0.4 µm )$$

at the location passed through by the viewing direction i on the further body surface on which the further diffraction structure is made to extend.

with K_{iSPH}:=aᵢ₃(SPHᵢₛₜ−SPHₛₒₗₗ) as a spherical imaging aberration of the point on the object surface,

with K_{iAST}:=aᵢ₄(ASTᵢₛₜ−ASTₛₒ₁₁) as an astigmatic imaging aberration of the point on the object surface.

with K_{iFF}=aᵢ₅(FFᵢₛₜ−FFₛₒₗₗ) as a chromatic imaging aberration of the point on the object surface,

where the coefficients aⱼₓ can be freely selected with x=1, 2, 3, 4, 5.

In the method, a geometry of the body, in particular a center thickness of the body and/or a front radius of the body and/or a back radius of the body, may have values which optimize the cost function K. In particular, in the method, the geometry of the body may have coefficients describing an aspherical shape or a free-surface shape of the spectacle lens front surface and/or the spectacle lens rear surface.

In the method, a positive refractive power may be specified for the spectacle lens, where the cost function K contains a cost function term K_{Rand} with:

K_{Rand}:=aₓ(RDᵢₛₜ−RDₛₒₗₗ),

where RDᵢₛₜ is an actual value for the center thickness of the spectacle lens and where RDₛₒₗₗ is a target value for the center thickness of the spectacle lens.

Alternatively, a negative refractive power may also be specified in the method, where the cost function K contains a cost function term K_{Rand} with:

K_{Rand}:=aₓ(RDᵢₛₜ−RDₛₒₗₗ),

where RDᵢₛₜ is an actual value for the edge thickness of the spectacle lens and where RDₛₒₗₗ is a target value for the edge thickness of the spectacle lens.

It should be noted that the grating vector \vec{k_{G38}} of the diffraction structure and the grating vector \vec{k_{G40}} of the further diffraction structure and also the geometry of the body may be optimized for at least one viewing direction of the observer in order to optimize at least one imaging aberration, described in the cost function K, of the viewing point in the eye of the observer.

A method according to the disclosure for producing a spectacle lens involves generating a phase object which contains at least one hologram of a first reference wave W₁₁ generated by means of a light modulator and a second reference wave W₁₂ generated by means of a light modulator or which contains a computer-generated hologram.

### BRIEF DESCRIPTION OF THE DRAWINGS

disclosureThe disclosure will now be described with reference to the drawings wherein:

FIG. 1 shows spectacles with a left and a right spectacle lens, which have a phase object.

FIG. 2 shows an observer with the spectacles;

FIG. 3 shows a section of the right spectacle lens of the spectacles shown in FIG. 1 with the right eye of the observer and with an object surface;

FIG. 4 shows the modulation of the refractive index in a diffraction structure of the phase object in the spectacle lens.

FIG. 5 shows a partial section of the led spectacle lens:

FIG. 6 shows the optical effect and properties of a first diffraction structure and a further diffraction structure of the phase object in the spectacle lens;

FIG. 7 shows the diffraction efficiency η of a diffraction structure for light in a spectacle lens in dependence on the angular deviation Δα from a line of sight ray diffracted by an angle α.

FIG. 8 shows the diffraction efficiency η of a diffraction structure formed as a multiplexing volume grating in a spectacle lens in dependence on the angular deviation Δα from a line of sight ray diffracted by an angle α:

FIG. 9a and FIG. 9b as well as FIG. 9c show the diffraction efficiency η of a diffraction structure for light in a spectacle lens for different angles of incidence of the light on the diffraction structure and different wavelengths λ of the light with different grating constants Λ_{G};

FIG. 10 shows a section of a further, right spectacle lens for spectacles with the right eye of an observer and with an object surface which has a first diffraction structure and a further diffraction structure with grating vectors and a geometry of the body of the spectacle lens which minimize a cost function;

FIG. 11 shows an enlarged partial view of the area XI in FIG. 10 with a line of sight ray;

FIG. 12 shows the distribution of refractive power and astigmatism as well as a color defect, in the spectacle lens shown m FIG. 1;

FIG. 13 shows the distribution of the refractive power and the astigmatism as well as a color defect in a spectacle lens without diffraction structures, which has a refractive power comparable to that of the spectacle lens shown in FIG. 1;

FIG. 14 shows the distribution of the refractive power and the astigmatism as well as a color defect in a spectacle lens with a first and a further diffraction structure with grating vectors and with a geometry of the body of the spectacle lens which minimize a cost function; and

FIG. 15 shows the distribution of the refractive power and the astigmatism as well as a color defect in a spectacle lens without diffraction structures which has a refractive power comparable to the refractive power of the spectacle lens taken as a basis for the distribution of the refractive power and the astigmatism as well as a color defect shown in FIG. 14.

### DESCRIPTION OF EXEMPLARY EMBODIMENTS

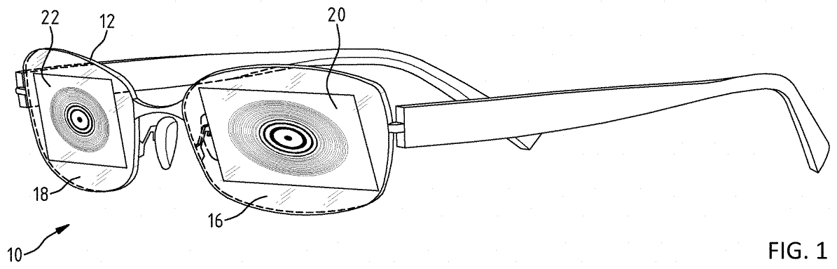

The spectacles 10 shown in FIG. 1 have a spectacle frame 12, in which a left spectacle lens 16 and a right spectacle lens 18 are mounted. The spectacles 10 may however also be designed as a monocle with only one spectacle lens. The spectacle lenses 16, 18 have in each case a body that is transparent to visible light. In principle, the structural form of the spectacle lens 16 corresponds to the structural form of the spectacle lens 18. The body of the spectacle lenses 16, 18 that is transparent to visible light is produced from a plastic that is transparent to visible light. In the transparent body of the spectacle lens 16 and of the spectacle lens 18 there are respectively phase objects 20, 22. These phase objects 20, 22 contain diffraction structures.

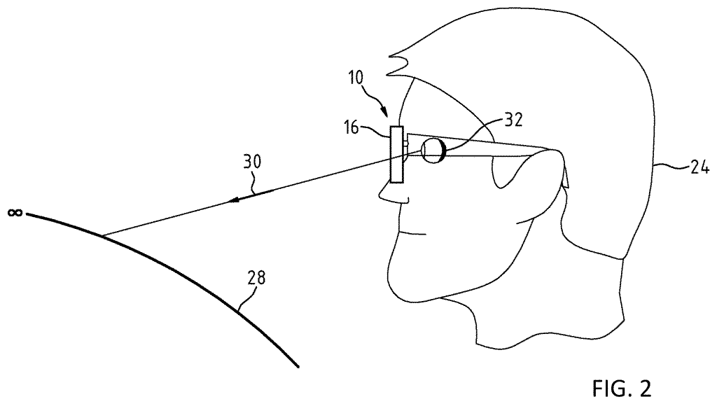

FIG. 2 shows an observer 24 with the spectacles 10 when observing an object surface 28. The transparent body of the left spectacle lens 16 is passed through by the viewing direction 30 of the led eye 32 of the observer 24. The same applies correspondingly to the transparent body of the right spectacle lens 18. The object surface 28 in FIG. 2 is a surface curved in two mutually perpendicular directions. When looking at different places on the object surface 28, the viewing direction 30 of the left eye 32 passes through the spectacle lens 16 and the viewing direction of the right eye passes through the spectacle lens 18 in different areas. By means of the left and right spectacle lenses 16, 18, a visual impairment of the left eye 32 and the right eye of the observer 24 is in this case compensated in such a way that the observer 24 sees the object surface 28 sharply at the different places.

For this purpose, the spectacle lenses 16, 18 have an optical effect that is matched to the left eye 32 and the right eye of the observer 24 and the course of the object surface 28 and the arrangement of the object surface 28 with respect to the observer 24. This optical effect can in particular be individualized for the observer 24. It should be noted that the object surface 28 may be a free-form surface. That is to say that the object surface 28 can in principle have any shape, for example the object surface 28 may be curved or pitched or else be a plane.

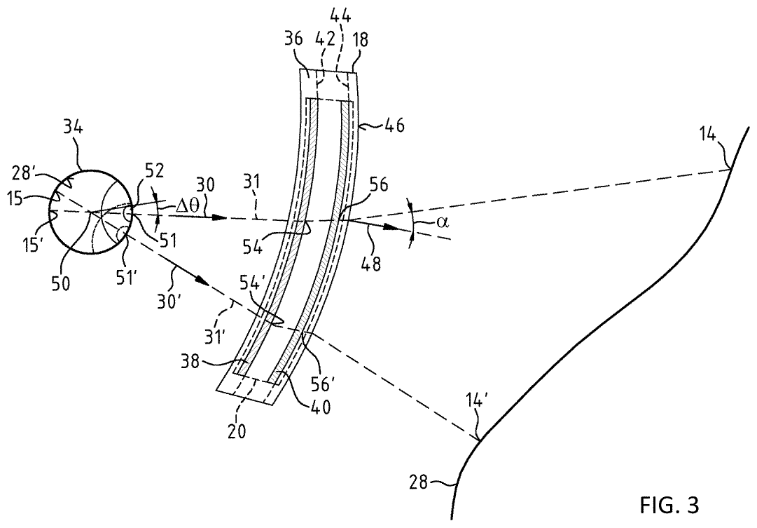

FIG. 3 is a section of the spectacle lens 18 from FIG. 1 with the right eye 34 of the observer 24 and the object surface 28 with different viewing directions 30, 30′. The body 36 of the spectacle lens 16 contains a carrier made of an optical plastic. In principle, the carrier in the body 36 may however also consist of a mineral glass. The phase object 20 in the body 36 of the spectacle lens 16 has an optical effect.

For this purpose, the phase object 20 has a first diffraction structure 38 in the form of a first grating formed as a volume grating and a further diffraction structure 40 in the form of a grating formed as a volume grating. The first diffraction structure 38 is made to extend in the body on a first body surface 42 which, when observing the object surface 28, is passed through by a line of sight ray 31, 31′. The line of sight ray 31, 31′ here passes through the body surface 42 at the point 54 or at the point 54′. The course of the line of sight ray 31, 31′ depends on the viewing direction 30, 30′. The line of sight ray 31, 31′ is a chief ray of the optical imaging into the image surface 28′ that is optically conjugate to the object surface 28 on the fundus of a point 14, 14′ on the object surface 28 observed by the observer 24 from the viewing direction 30, 30′. The line of sight ray 31, 31′ in this case extends through the center of rotation of the eye 50 and the pupil center 51, 51′.

The further diffraction structure 40 is also made to extend in the body of the spectacle lens 16 on a further body surface 44, which is passed through at the points 56, 56′ when observing the object surface 28 from the light of sight ray 31, 31′ corresponding to the viewing direction 30, 30′ of the eye 34 of the observer 24. As shown in FIG. 3, the line of sight ray 31, 31′ is generally refracted when passing through the spectacle lens and is diffracted in the phase object 20 by the diffraction structures 38, 40.

It should be noted that the body surfaces 42, 44 are cut surfaces of the spectacle lens 16, 18, which may in particular be curved. It should also be noted that the body surfaces 42, 44 along which the diffraction structures 38, 40 of the phase object 20 are made to extend in a spectacle lens 16, 18 may also coincide. In this case, the diffraction structures 38, 40 of the phase object 20 in a spectacle lens 16, 18 lie against one another and the diffraction structures 38, 40 are then not spaced apart from one another.

The phase object 20 directs the light incident on a spectacle lens front surface 46 of the spectacle lens 16 facing away from the observer 24 on a line of sight ray 31, 31′ at an angle of incidence α to the local surface normal 48 in a direction that is dependent on the wavelength λ of the light and on the angle of incidence α of the light.

For this purpose, the first diffraction structure 38 and the further diffraction structure 40 are in each case formed by a spatial modulation of the refractive index n(x, y):=nₒ+Δn sin(F(x, y)) dependent on the locations 54, 54′, 56, 56′ in the body surfaces 42, 44 that are passed through by the viewing direction.

The spatial modulation of the refractive index n(x, y) that forms the first diffraction structure 38 and the further diffraction structure 40 in the body 36 of a spectacle lens 16, 18 that can be passed through by different viewing directions when the spectacles 10 shown in FIG. 1 are worn is in each case a continuous function of the location in the body surfaces 42, 44 in the spectacle lens 18. The diffraction structures 38, 40 in the phase object 20 of the spectacle lens 18 convert a spherical light wave which originates from a point 14, 14′ on the object surface 28 that can be observed by the observer 24 from the respective viewing direction 30, 30′ into a light wave, running along the line of sight rays 31, 31′, which projects an image of the point 14, 14′ on the object surface 28 onto an image point 15, 15′ in the eye 34 of the observer lying in the image surface 28′ that is optically conjugate to the object surface 28.

It should be noted that, in a manner corresponding to the right spectacle lens 18, the left spectacle lens 16 brings about an optical imaging onto the fundus of points 14, 14′ on the observed object surface 28 that lie on line of sight rays corresponding to the viewing direction of the eye of the observer 24 that is then on the right.

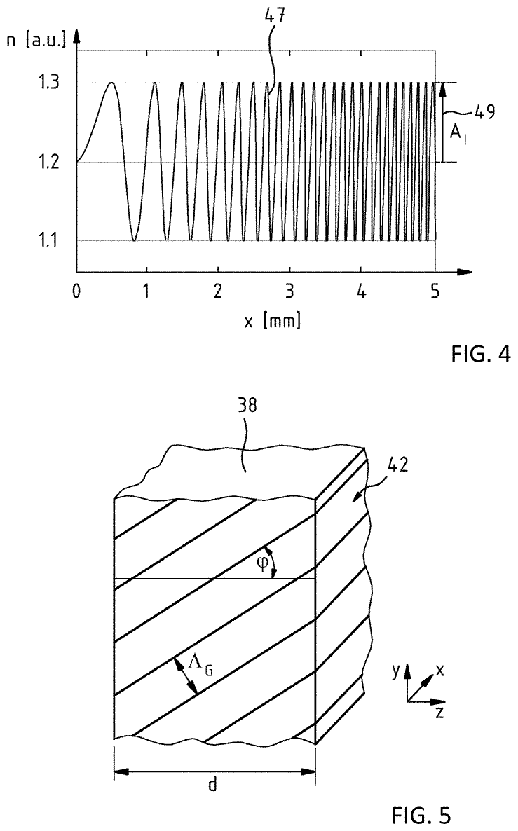

FIG. 4 shows the continuous modulation 47 of the refractive index n along a curve running in the body surface 42 from FIG. 3 with the amplitude 49 in a portion of the diffraction structure 38. FIG. 5 is a portion of the diffraction structure 38 made to extend on the body surface 42 in the spectacle lens 18. The diffraction structure 38 is a volume grating which has a constant thickness d and the grating vector of which

$$\vec{{k}_{G 38}} := \frac{2 }{{Λ}_{x}} \vec{{e}_{x}} + \frac{2 }{{Λ}_{y}} \vec{{e}_{y}} + \frac{2 }{{Λ}_{z}} \vec{{e}_{z}}$$

has a dependent direction which is in principle location-dependent, where Λₓ, Λ_{y}, Λ_{z} are the local grating constants of the volume grating of the diffraction structure 38 in the three different spatial directions.

In the diffraction structure 38, the grating constants Λₓ and Λ_{y} are in this case linked by the following relation.

$${Λ}_{x} = 1 / \frac{\partial f ( x , y )}{\partial x}$$

$$and$$

$${Λ}_{y} = 1 / \frac{\partial f ( x , y )}{\partial y}$$

where f(x, y) is a continuously differentiable number-of-grooves function optimized for the required optical transfer function of the diffraction structure according to the location variables x and y and where

$$\frac{\partial f ( x , y )}{\partial x} and \frac{\partial f ( x , y )}{\partial y}$$

has the physical meaning of the groove density of the grating in the x and y directions.

The absolute value of the grating vector

$$\vert \vec{{k}_{G 38}} \vert := \vert \frac{2 }{{Λ}_{x}} \vec{{e}_{x}} + \frac{2 }{{Λ}_{y}} \vec{{e}_{y}} + \frac{2 }{{Λ}_{z}} \vec{{e}_{z}} \vert$$

is constant in the diffraction structure 38. For the grating constant,

$${Λ}_{G 38} := \frac{2 π}{\vert \vec{{k}_{G 38}} \vert}$$

the following applies here:

Λ_{G}=2.4 μm

It should be noted that in principle other values can also be selected here as a value tor the grating constant Λ_{G}, typically values for which the following applies:

2.0 μm≤|\vec{k_{G38}}|≤2.8 μm.

It should also be noted that, in a modified embodiment of the disclosure, the grating vector amount |\vec{k_{G38}}| may be a generally non-constant scalar function F₃₈(x, y) dependent on the location in the body surface 42.

The diffraction structure 40 in a spectacle lens 16, 18 is likewise a volume grating which has a constant thickness d and the grating vector of which

$$\vec{{k}_{G 40}} := \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}}$$

again has a constant amount, but a location-dependent direction.

It should be noted however that, in a modified embodiment of the disclosure, the grating vector amount |\vec{k_{G40}}| may be a generally non-constant scalar function F₄₀(x, y) dependent on the location in the body surface 42.

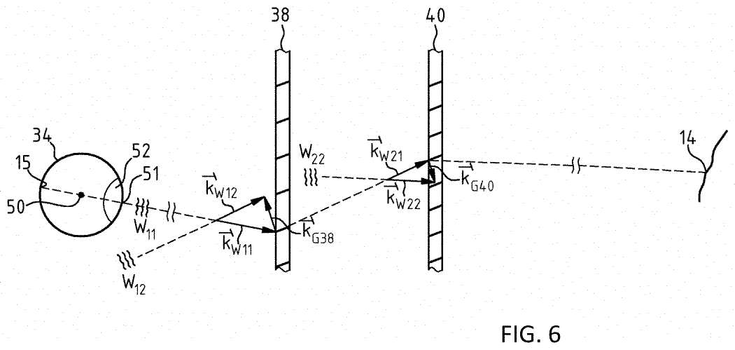

FIG. 6 explains the optical effect and properties of the first diffraction structure 38 and the further diffraction structure 40 of the phase object 20 in the spectacle lens 16.

The volume grating of the first diffraction structure 38 has on the side facing the eye 34 of the observer 24 a groove density

$${F}_{x} ( x , y ) = \frac{\partial f ( x , y )}{\partial x}$$

$${F}_{y} ( x , y ) = \frac{\partial f ( x , y )}{\partial y}$$

which ensures that a point 14 lying on the line of sight ray 31 on the object surface 28 is diffracted as an image point 15 onto the fundus of the eye 34 of the observer 24.

This property of the diffraction structure 38 has the effect that the direction of the grating vector

$$\vec{{k}_{G 38}} := \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}}$$

in the volume grating of the diffraction structure must be adapted to every possible line of sight ray 31 through the spectacle lens 16, 18, since the amount |\vec{k_{G38}}| of the grating vector in the diffraction structure 38 is constant.

Since this adaptation is performed by the first diffraction structure 38 being a hologram of a first reference wave W₁₁ and a second reference wave W₁₂, wherein the first reference wave W₁₁ is a spherical wave of a point light source arranged in the eye 34 of the observer 24 at or in the vicinity of the point of rotation of the eye 50, it can be achieved that the diffraction structure 38 the light that is emitted from a point 14 on the object surface 28 lying on a line of sight ray 31 and passes through the pupil 52 of the eye 34 of the observer is diffracted with a maximum diffraction efficiency η into an image point 15 on the image surface 28′ that is conjugate to the object surface 28.

For this purpose, at each place that can be passed through by the line of sight ray 31, 31′ on a side of the diffraction structure 38 facing the observer 24, the wavefront vector \vec{k_{W11}} of the first reference wave W₁₁ and the wavefront vector \vec{k_{W12}} of the second reference wave W₁₂ and also the grating vector \vec{k_{G38}} of the hologram are linked as follows:
i) \vec{k_{W11}}=\vec{k_{W12}}−\vec{k_{G38}}.

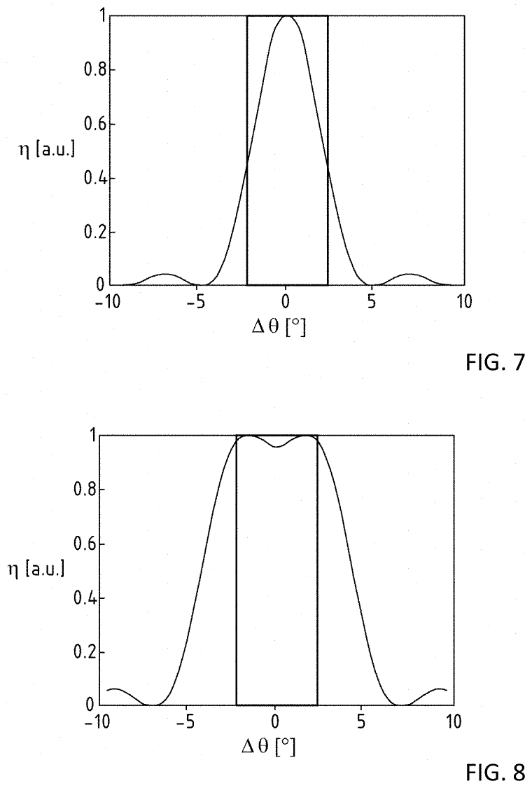

FIG. 7 shows the diffraction efficiency η of the diffraction structure 38 for light which is diffracted through the pupil 52 into the eye 34 of the observer 24 at an angle Δθ to a line of sight ray 31 as shown in FIG. 3. As can be seen from FIG. 7, the diffraction structure 38, which is a hologram of a first reference wave W₁₁ and a second reference wave W₁₂, wherein the first reference wave W₁₁ is a spherical wave of a point light source arranged in the eye 34 of the observer 24 at or in the vicinity of the point of rotation of the eye 50, ensures that not only the light on a line of sight ray 31 but also the light that enters the eye 34 of the observer at the angle −2.5°≤Δθ≤2.5° is diffracted by means of the diffraction structure 38.

It should be noted that, since the hologram of the diffraction structure 38 is a hologram of two pairs of reference waves P1=(W₁₁, W₁₂); P2=(W₂₁, W₂₂) or a number of pairs of reference waves Pᵢ (Wᵢ₁, Wᵢ₂), i=1, 2, 3 . . . , it can be ensured that the diffraction structure 38 acts as a multiplexing volume grating and thus allows diffraction with the diffraction efficiency η shown in FIG. 8 of light which falls into the eye 34 of the observer 24 at the angle Δθ to a line of sight ray 31. For light incident at the angle −2.5°≤Δθ≤2.5° to a line of sight ray, the diffraction efficiency η here is more than 95%.

The further diffraction structure 40 shown in FIG. 3 and FIG. 6 in the spectacle lens 16, 18 has the function of minimizing, and if possible compensating for, a color defect caused by the dispersion in the diffraction structure 38.

For this purpose, the further diffraction structure 40 is also a hologram of a further first reference wave W₂₁ and a further second reference wave W₂₂. At each place that can be passed through by the line of sight ray 31, 31′ on a side of the further diffraction structure 40 facing the observer 24, the following applies here for the wavefront vector \vec{k_{W21}} of the further first reference wave W₂₁ and the wavefront vector \vec{k_{W22}} of the further second reference wave W₂₂ and also the grating vector \vec{k_{G40}} of the hologram:
i) \vec{k_{W21}}=\vec{k_{W22}}−\vec{k_{G40}},

wherein the further first reference wave W₂₁ is the first reference wave W₁₁ diffracted by means of the at least one diffraction structure or the second reference wave W₁₂ diffracted by means of the at least one diffraction structure to the hologram of the first diffraction structure 38.

The diffraction structure 40 in the phase object 20 of the spectacle lens 18 diffracts the light diffracted into a first order of diffraction O1 by means of the diffraction structure 38 into an order of diffraction O2 opposite to this order of diffraction, where:

|O1=|O2|

and

sign(O1)=−sign(O2).

It should be noted hat the hologram of the diffraction structure 40 may likewise be a hologram of two pairs of reference waves P1=(W₁₁, W₁₂); P2=(W₂₁, W₂₂) or a number of pairs of reference waves Pᵢ (Wᵢ₁, Wᵢ₂), i=1, 2, 3 . . . . Such a diffraction structure acts as a multiplexing volume grating and allows diffraction with a high diffraction efficiency η of light which is incident on the spectacle lens front surface 46 at an angle of incidence α lying within an angular range α±Δα to a surface normal 48.

The grating vector \vec{k_{G38}} and the grating vector \vec{k_{G40}} in the diffraction structure 38 and the diffraction structure 40 of the phase object 20 has a direction that is in principle dependent on the location in the spectacle lens 16, 18, which ensures that the imaging aberration of the image point in the eye 32, 34 of the observer 24 is minimal.

The direction of the grating vector \vec{k_{G38}} and the grating vector \vec{k_{G40}} in the diffraction structure 38 and the diffraction structure 40 is for this purpose optimized in an optimization method for the smallest possible imaging aberration. The imaging aberration may in this case correspond to one imaging aberration or a number of imaging aberrations from the group comprising color defect, astigmatism, coma.

The direction of the grating vector \vec{k_{G38}} and the grating vector \vec{k_{G40}} in the diffraction structure 38 and the diffraction structure 40 can alternatively or additionally also be optimized in such a way that for the possible different viewing directions 30, 30′of the observer 24 through the spectacle lens 16, 18 is a diameter of the image point in the eye 32, 34 of the observer 24 is minimal. Alternatively or additionally, the optimizing of the grating vector \vec{k_{G38}} and the grating vector \vec{k_{G40}} in the diffraction structure 38 and the diffraction structure 40 may also take place in such a way that the diffraction efficiency η for the light incident on the spectacle lens 16, 18 in directions corresponding to different possible viewing directions is as great as possible.

It should be noted that, in the case of grating vector amounts |\vec{k_{G38}}|, |\vec{k_{G40}}| of the grating vector \vec{k_{G38}}, \vec{k_{G40}} of the diffraction structures 38, 40, which are dependent on the location in the body surfaces 42, 44, a grating vector \vec{k_{G38}}, \vec{k_{G40}} may have for at least one viewing direction 30, 30′ of the observer 24 a grating vector amount that optimizes an imaging aberration of the image point 15, 15′. It should be noted that the imaging aberration may correspond to one imaging aberration or a number of imaging aberrations from the group comprising color defect, astigmatism, coma and defocus. Alternatively or additionally, the grating vector |\vec{K_{G38}}|, |\vec{k_{G40}}| may also have for at least one viewing direction 30, 30′ of the observer 24 a grating vector amount that optimizes a diameter of an image point 15, 15′.

This optimization may take place for example on the basis of a cost function that evaluates imaging aberrations and/or color defects and/or the diffraction efficiency η of the diffraction structures 38, 4 in the spectacle lens 16, 18.

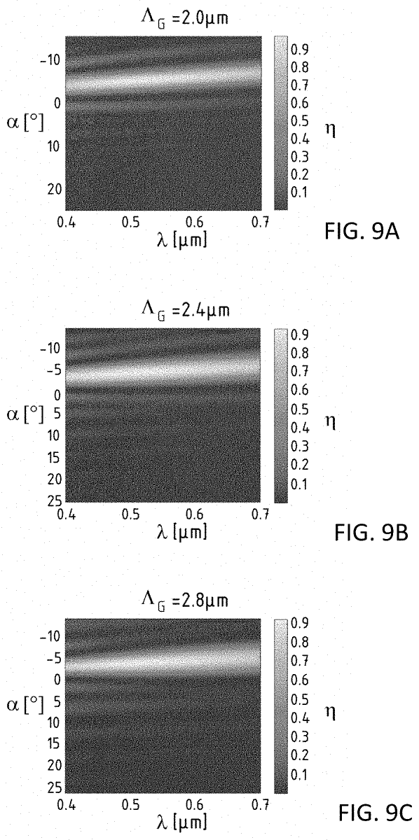

FIG. 9a shows the diffraction efficiency η of a diffraction structure for light in a spectacle lens for different angles of incidence α and of the light and different wavelengths λ of the light on a diffraction structure with the grating constant Λ_{G}=2.0 μm. In FIG. 9b, the diffraction efficiency η of a corresponding diffraction structure for light with the grating constant Λ_{G}=2.4 μm can be seen. FIG. 9c shows the diffraction efficiency η o fa diffraction structure for light in a spectacle lens for different angles of incidence α and of the light and different wavelengths λ of the light on a diffraction structure with the grating constant Λ_{G}=2.8 μm.

It can be seen from FIGS. 9a, 9b and 9c that a change in the grating constant Λ_{G} in the interval 2.0 μm≤2π/|\vec{k_{G38}}|=|Λ_{G}|≤2.8 μm or 2.0 μm≤2π/|\vec{k_{G40}}|=|Λ_{G}|≤2.8 μm has only a slight influence on the diffraction efficiency η of the diffraction structure in the spectacle lens, so that a variation of grating vector amounts |\vec{k_{G38}}|, |\vec{k_{G40}}| of the grating vector \vec{k_{G38}}, \vec{k_{G40}} does not affect the diffraction efficiency η of the diffraction structure in the spectacle lens.

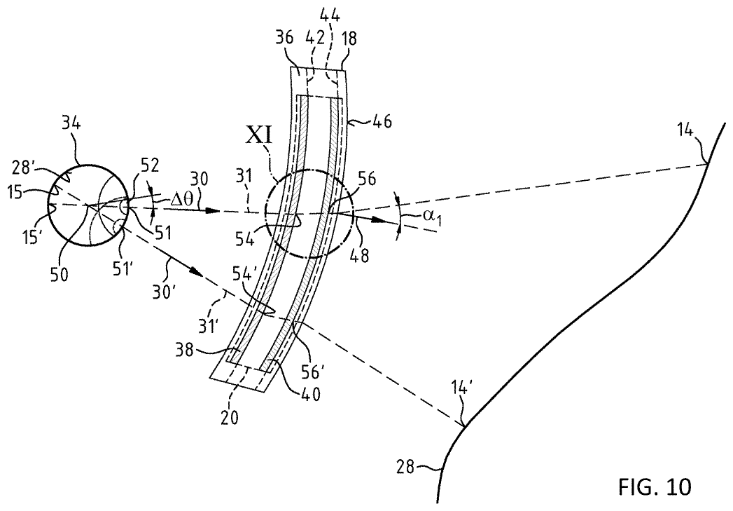

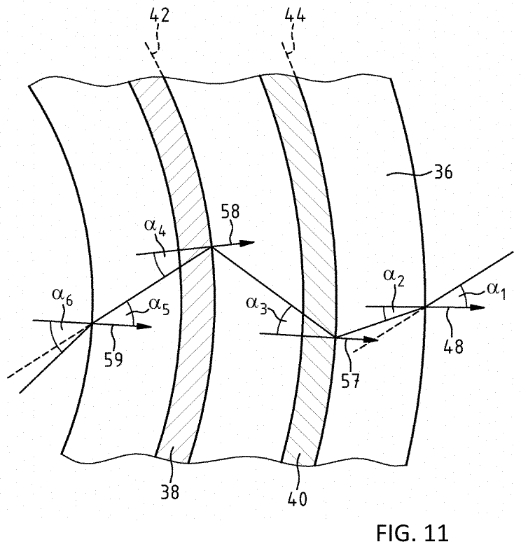

FIG. 10 shows a section of a further, right spectacle lens 18′ for spectacles with the right eye 34 of an observer and with an object surface 28 and an object surface with different viewing directions 30, 30′. FIG. 11 is an enlarged partial view of the section with a line of sight ray 31 for the viewing direction 30.

The body 36 of the spectacle lens 18′ also contains here a carrier made of an optical plastic. In principle, the carrier in the body 36 may however also consist e.g. of a mineral glass. IN the body 36 of the spectacle lens 18′ there is again a phase object 20 with an optical effect.

The phase object 20 contains a diffraction structure 38. The phase object 20 and the body 36 directs the light incident on a side of the spectacle lens 18′ facing away from the observer 24 with respect to the surface normal 48 at an angle of incidence α₁ to a surface normal 48 of the spectacle lens front surface 46 from a point 14, 14′ on the object surface 28 in a direction dependent on the wavelength λ of the light and on the angle of incidence α₁ of the light.

Both the first diffraction structure 38 and the further diffraction structure 40 are formed as a volume grating. The first diffraction structure 38 is made to extend in the body on a first body surface 42 which, when observing the object surface 28, is passed through by a line of sight ray 31, 31′. The line of sight ray 31, 31′ here passes through the body surface 42 at the point 54 or at the point 54′. The course of the line of sight ray 31, 31′ depends on the viewing direction 30, 30′. The line of sight ray 31, 31′ is a chief ray of the optical imaging into the image surface 28′ that is optically conjugate to the object surface 28 on the fundus of a point 14, 14′ on the object surface 28 observed by the observer 24 from the viewing direction 30, 30′. The line of sight ray 31, 31′ in this case extends through the center of rotation of the eye 50 and the pupil center 51, 51′.

The further diffraction structure 40 is also made to extend in the body of the spectacle lens 18′ on a further body surface 44, which is passed through at the points 56, 56′ when observing the object surface 28 from the line of sight ray 31, 31′ corresponding to the viewing direction 30, 30′ of the eye 34 of the observer 24. As shown in FIG. 10, the line of sight ray 31, 31′ is generally refracted when passing through the spectacle lens and is diffracted in the phase object 20 by the diffraction structures 38, 40.

It should be noted that the body surfaces 42, 44 are cut surfaces of the spectacle lens 18′, which may in particular be curved. It should also be noted that the body surfaces 42, 44 along which the diffraction structures 38, 40 of the phase object 20 are made to extend in the spectacle lens 18′ may also coincide. In this case, the diffraction structures 38, 40 of the phase object 20 in a spectacle lens 18′ lie against one another and the diffraction structures 38, 40 are then not space apart from one another.

For this purpose, the first diffraction structure 38 and the further diffraction structure 40 are in each case formed by a spatial modulation of the refractive index n(x, y):=nₒ+Δn sin(F(x, y)) dependent on the locations 54, 54′, 56, 56′ in the body surfaces 42, 44 that are passed through by the viewing direction.

The spatial modulation of the refractive index n(x, y) that forms the first diffraction structure 38 and the further diffraction structure 40 in the body 36 of a spectacle lens 16, 18 that can be passed through by different viewing directions when spectacles corresponding to the spectacles 10 shown in FIG. 1 are worn is in each case a continuous function of the location on the body surfaces 42, 44 in the spectacle lens 18. The diffraction structures 38, 40 in the phase object 20 of the spectacle lens 18 convert a spherical light wave which originates from a point 14, 14′ on the object surface 28 that can be observed by the observer 24 from the respective viewing direction 30, 30′into a light wave, running along the line of sight rays 31, 31′, which projects an image of the point 14, 14′ on the object surface 28 onto an image point 15, 15′ in the eye 34 of the observer lying in the image surface 28′ that is optically conjugate to the object surface 28.

The modulation of the refractive index forming the first diffraction structure 38 and the further diffraction structure 40 is continuous over a contiguous area b of the body surface 42, for the diameter D of which, defined as the supremum of the metric distance d(x,y) between two arbitrary point x, y arranged in the area of the body surface 42, the following applies:

D:=su{d(x, y): x, y ∈ B}≥20 mm,

For the light incident on a side of the spectacle lens 18′ facing away from the observer 24 with respect to the surface normal 48 at the angle of incidence α₁ to the surface normal 48 of the spectacle lens front surface 46 from the point 14, 14′ on the object surface 28, the body 36 is a refractive body with a refractive dispersion D_{ref.1} with

$${D}_{ref .1} := \frac{\partial {α}_{2}}{\partial λ} = \frac{\partial }{\partial λ} asin ( \frac{{n}_{1} ( λ ) sin {α}_{1}}{{n}_{2} ( λ )} ) .$$

The body 36 for the light exiting on a side of the spectacle lens 16, 18 facing the observer 24 with respect to the surface normal 59 at the exit angle α₆, which comes from the point 14, 14′ on the object surface 28, is in this case a refractive body with a refractive dispersion D_{ref.2} with

$${D}_{ref .2} := \frac{\partial {α}_{6}}{\partial λ} = \frac{\partial }{\partial λ} asin ( \frac{{n}_{2} ( λ ) sin {α}_{6}}{{n}_{3} ( λ )} ) .$$

Here, n₁(λ) is the refractive index, generally dependent on the wavelength λ, of the optical medium arranged between the object surface 28 and the body 36 for the light, v n₂(λ) is the refractive index, generally dependent on the wavelength λ, of the body 36 for the light, n₃(λ) is the refractive index, generally dependent on the wavelength λ, of an optical medium for the light arranged between the pupil 52 and the body 36.

The diffraction structure 38 has for the light incident on a side of the spectacle lens 18′ facing away from the observer 24 with respect to the surface normal 48 at the angle of incidence α₁ to the surface normal 48 of the spectacle lens front surface 46 from the point 14, 14′ on the object surface 28 a diffractive dispersion D_{diff.1} that compensates at least partially for the refractive dispersion D_{ref.}:=D_{ref.1}+D_{ref.2} of the body 36.

In this case, the following applies:

$$i ) {D}_{diff .1} := \frac{\partial {α}_{4}}{\partial λ} = \frac{m}{{Λ}_{proj .38} cos {α}_{4}} . \qquad$$

Here, α₄ is a deflection angle, related to a surface normal 58 at a place of the body surface 42 on which the diffraction structure 38 is made to extend that is passed through by the light incident on the spectacle lens front surface at the angle of incidence α₁ to the surface normal 48 of the spectacle lens front surface 46 from the point 14, 14′ on the object surface 28, for the light incident on the spectacle lens front surface at the angle of incidence α₁ to the surface normal 48 of the spectacle lens front surface 46 from the point 14, 14′ on the object surface 28.

The diffraction structure 38 is a hologram of at least a first reference wave W₁₁ and second reference wave W₁₂, which is formed as an optical grating that has a local grating period vector

\vec{Λ_{G38}}:=Λ₃₈ₓ\vec{eₓ}+Λ_{38y}\vec{e_{y}}+Λ_{38z}\vec{e_{z}}

and a local grating vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

with a grating vector amount

$$i ) \vert \vec{{k}_{G 38}} \vert := \vert \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}} \vert .$$

Λ_{proj.38} is the grating period of the projection of the grating vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

onto body surface (42) with

$${Λ}_{proj .38} := \frac{2 π}{\vert \frac{2 π}{{Λ}_{38 x}} \vec{{e}_{x}} + \frac{2 π}{{Λ}_{38 y}} \vec{{e}_{y}} \vert} .$$

The further diffraction structure 40 in the spectacle lens 18′ diffracts the light diffracted into a first order of diffraction O1 by the diffraction structure 38 into an cider of diffraction O2, for which the following applies:

|O1|=|O2| and sign(O1)=−sign(O2).

The further diffraction structure 40 in the spectacle lens 18′ is made to extend on a further body surface 44, which may coincide with the first body surface 42 and is formed by a spatial modulation of the refractive index n(x, y) dependent on the location 54, 56 in the body surface 44.

The further diffraction structure 40 is a hologram of at least one further first reference wave W₂₁ and a further second reference wave W₂₂.

The further first reference wave W₂₁ is in this case the first reference wave W₁₁ diffracted by means of the at least one diffraction structure 38 or the second reference wave W₁₂ diffracted by means of the at least one diffraction structure 38.

In this case, the hologram of the further diffraction structure 40 is formed as a further optical grating that has a local grating period vector

\vec{Λ_{G40}}:=Λ₄₀ₓ\vec{eₓ}+Λ_{40y}\vec{e_{y}}+Λ_{40z}\vec{e_{z}}

and a local grating vector

$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

with a grating vector amount

$$\vert \vec{{k}_{G 40}} \vert := \vert \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}} \vert .$$

For the light incident on a side of the spectacle lens 18′ facing away from the observer 24 with respect to the surface normal 48 at the angle of incidence α₁ to the surface normal 48 of the spectacle lens front surface 46 from, the point 14, 14′ on the object surface 28 and then refracted to the angle α₂ with respect to the surface normal 48, the further diffraction structure 40 has a diffractive dispersionD_{diff.2} for which the following applies:

$${D}_{diff .2} := \frac{\partial {α}_{3}}{\partial λ} = \frac{m}{{Λ}_{proj .40} cos {α}_{3}} .$$

Δ_{proj.40} is in this case the grating period of the projection of the grating vector of the further optical grating

$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

onto the further body surface 44 with

$${Λ}_{proj .40} := \frac{2 π}{\vert \frac{2 π}{{Λ}_{40 x}} \vec{{e}_{x}} + \frac{2 π}{{Λ}_{40 y}} \vec{{e}_{y}} \vert} .$$

Here, α₃ is a deflection angle, related to a surface normal 57 at a place of the further body surface 44 on which the further diffraction structure 40 is made to extend that is passed through by the light incident on the spectacle lens front surface at the angle of incidence α₁ to the surface normal 48 of the spectacle lens front surface 46 from the point 14, 14′ on the object surface 28, for the light incident on the spectacle lens front surface at the angle of incidence α₁ to the surface normal 48 of the spectacle lens front surface 46 from the point 14, 14′ on the object surface 28.

In the case of the spectacle lens 18′, the refractive dispersions satisfy errors! A number was expected, and errors! A number was expected, with the diffractive dispersion errors! A number was expected. And errors! A number was expected, the following relation

sign(D_{ref.1}+D_{ref.2})=−sign(D_{diff.1}+D_{diff.2})

In this case, the following applies:
i) |D_{ref.1}+D_{ref.1}+D_{diff.1}+D_{diff.1}|≤S,

with S=0.72 cm/m, typically S=0.36 cm/m, particularly typically S=0.12 cm/m.

In the spectacle lens 18′, the grating vector \vec{k_{G38}} of the diffraction structure 38 and the grating vector \vec{k_{G40}} of the further diffraction structure 40 have grating vector amounts |\vec{k_{G38}}|, |\vec{k_{G40}}| that optimize a cost function K for a large number of different viewing directions i, which contains a cost function term \tilde{K} with:

\tilde{K}:=ΣᵢKi

and

Kᵢ:=K_{iGP1}+K_{iGP2}+K_{iGP2}+K_{iSPH}+K_{iFF},

with

$${K}_{iGP 1} := {a}_{1} ( \vert \frac{2 π}{\vert \vec{{k}_{G 38}} \vert} - 2.4 µm \vert - 0.4 µm )$$

at the location 54 passed through by the viewing direction i on the body surface 42 on which the diffraction structure 38 is made to extend,

with

$${K}_{iGP 2} := {a}_{2} ( \vert \frac{2 π}{\vert \vec{{k}_{G 40}} \vert} - 2.4 µm \vert - 0.4 µm )$$

at the location 56 passed through by the viewing direction i on the further body surface 44 on which the further diffraction structure 40 is made to extend,

with K_{iSPH}:=aᵢ₃(SPHᵢₛₜ−SPHₛₒₗₗ) as a spherical imaging aberration of the point 14 on the object surface 28.

with K_{iAST}:=aᵢ₄(ASTᵢₛₜ−ASTₛₒₗₗ) as an astigmatic imaging aberration of the point 14 on the object surface 28,

with K_{iFF}=aᵢ₅(FFᵢₛₜ−FFₛₒₗₗ) as a chromatic imaging aberration of the point 14 on the object surface 28,

where the coefficients aᵢₓ can be freely selected with x=1, 2, 3, 4, 5.

The grating vector \vec{k_{G38}} of the diffraction structure 38 and the grating vector \vec{k_{G40}} of the further diffraction structure 40 and also the geometry of the body 36 are optimized for at least one viewing direction 30 of the observer 24 in order to optimize at least one imaging aberration, described in the cost function K, of the viewing point in the eye 32, 34 of the observer, i.e. to keep it as small as possible. In the spectacle lens 18′, the center thickness of the body 36 and a front radius of the body 36 and a rear radius of the body 36 therefore have values which optimize the cost function K, wherein the geometry of the body 36 has coefficients describing an aspherical shape. It should be noted that the geometry of the body 36 may alternatively or additionally also have coefficients describing a free-surface shape of the spectacle lens front surface 46 and/or a free-surface shape of the spectacle lens rear surface.

The spectacle lens 18′ has a positive refractive power, where the cost function K contains a cost function term K_{Rand} with: K_{Rand}:=aₓ(RDᵢₛₜ−RDₛₒₗₗ), where RDᵢₛₜ is an actual value for the center thickness of the spectacle lens and where RDₛₒₗₗ is a target value tor the center thickness of the spectacle lens.

It should be noted that the spectacle lens 18′ may also have a negative refractive power, where the cost function K then contains a cost function term K_{Rand} with: K_{Rand}:=aₓ(RDᵢₛₜ−RDₛₒₗₗ), where RDᵢₛₜ is an actual value for the edge thickness of the spectacle lens and where RDₛₒₗₗ is a target value for the edge thickness of the spectacle lens.

It should be noted that the right spectacle lens 18′ described above can in principle also be a left spectacle lens, like the spectacle lens 16 that can be seen in FIG. 1. The optical imaging of points 14, 14′ on the observed object surface 28 onto the fundus brings about the effect here that corresponding line of sight rays lie on the viewing direction of the eye of the observer 24 that is then on the right.

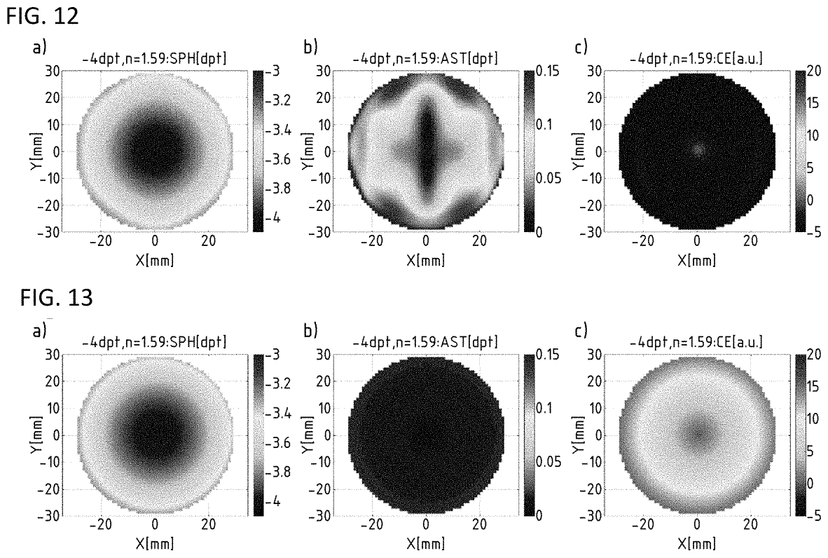

FIG. 12 shows the distribution of the refractive power and the astigmatism as well as a color defect for the spectacle lens 18′ shown in FIG. 10. The prescription effect of the spectacle lens 18′ is a spherical effect of −4 diopters and an astigmatism of 0 diopters. In FIG. 12, the variance of the spherical effect and the astigmatism in diopters as well as the lateral chromatic aberration in a self-selected unit are visualized for the spectacle lens 18′.

Because of the optimization, the edge thickness of the spectacle lens is reduced as much as possible. The spectacle lens blank on which the spectacle lens 18′ is based is circular and has the diameter d=60 mm. It consists of a material with a refractive index of 1.59 (d line) in order to achieve a spherical effect of −4 diopters, especially in the center of the lens, with the lowest possible astigmatism.

The resulting distributions of spherical effect, astigmatism and lateral chromatic aberration are shown in portions a), b) and c) of FIG. 12. In the case of the spectacle lens 18′, the spherical effect varies between approximately −4 diopters in the center and approximately −3.4 diopters at the edge of the lens. The astigmatism is close to zero. The color defect is at a value of around 13 in our self-selected unit, which corresponds to color fringes of up to 2.9 mm/m. The edge thickness of the spectacle lens at a height of 30 mm is 4.50 mm. For mounting m a spectacle frame, the spectacle lens 18′ is cut out from the circular spectacle lens blank, on which it is based.

FIG. 13 shows the distribution of the refractive power and the astigmatism as well as a color defect in a spectacle lens without diffraction structures, which has a refractive power comparable to the spectacle lens shown in FIG. 12, as a reference. The center thickness d₁₃ of the spectacle lens on which FIG. 13 is based and the center thickness d₁₈ of the spectacle lens on which FIG. 12 is based are the same. The following applies: d₁₃=d₁₈=1.2 mm. The material of the spectacle lenses on which FIG. 12 and FIG. 13 are based has the refractive index n=1.59 (n₄ line) and the Abbe number v=41.11.

The color defect of the reference also has the approximation formula common in ophthalmic optics “fringe per meter=prism/Abbe number”. The prism is approximated here as a product of the prescription effect of the spectacle lens in diopters and viewing height. A color fringe of for example 2 mm per meter indicates that a black object on a white background at a distance of one meter has a color fringing of 2 mm (measured in the object plane).

FIGS. 12 and 13 show that the disclosure makes it possible to significantly reduce the color defects of a spectacle lens. The color defect of the spectacle lens on which FIG. 12 is based is below the perception threshold of 0.12 cm/m. The edge thickness dᵣ₁₈ of this spectacle lens, at dᵣ₁₈=3.8 mm, is around 0.7 mm smaller than the edge thickness r₁₃=4.6 mm of the spectacle lens on which FIG. 13 is based.

It should be noted that the edge thickness can in principle also be reduced by the optimization described above to values that are even smaller. However, reducing the edge thickness is accompanied here by an increase in the color defect, since the color defect of the body 36 of the spectacle lens 18′ is already overcompensated by the color defect of the diffraction structures 38, 40 in the spectacle lens of FIG. 12.

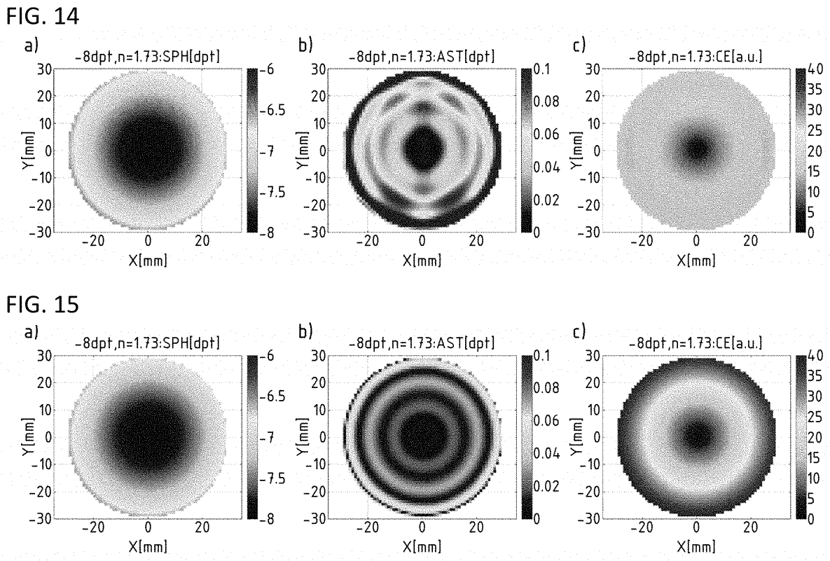

FIG. 14 shows the distribution of the refractive power and the astigmatism as well as a color defect in a spectacle lens with a first and a further diffraction structure with grating vectors and with a geometry of the body of the spectacle lens which minimize a cost function. The prescription effect of the spectacle lens is a spherical effect of −8 diopters and an astigmatism of 0 diopters.

FIG. 15 shows the distribution of the refractive power and the astigmatism as well as a color defect in a spectacle lens without diffraction structures which has a refractive power comparable to the refractive power of the spectacle lens taken as a basis for the distribution of the refractive power and the astigmatism as well as the color defect shown in FIG. 14. The center thickness of the spectacle lenses in FIGS. 14 and 15 is in each case 1.2 mm. The spectacle lenses from FIG. 14 and FIG. 15 are made of a material with a refractive index of 1.73 (n_{d} line) and an Abbe number of 32.15.

The example of the spectacle leases in FIGS. 14 and 15 differs from the example of the spectacle lenses in FIGS. 12 and 13 in that it has a significantly higher spherical effect of −8 diopters. FIG. 14 and FIG. 15 show that, even with such a great spherical effect, a significant reduction in the color defect can be achieved without causing changes in the variance of the spherical effect or astigmatism that disturb an observer. It should be noted that the following applies for the edge thickness dᵣ₁₄ of the spectacle lens on which FIG. 14 is based: dᵣ₁₄=5.5 mm, wherein the spectacle lens on which FIG. 15 is based has the edge thickness dᵣ₁₅=5.7 mm.

It should also be noted that a spectacle lens with a phase object 20 described above can be produced by generating the phase object 20 by generating at least one hologram of a first reference wave W₁₁ generated by means of a light modulator and a second reference wave W₁₂ generated by means of a light modulator or by the hologram being generated by means of a computer.

The project that led to the application for a patent for the disclosure is a project funded by the European Union's Horizon 2020 research and innovation program under the Marie Skodowska-Curie grant agreement No. 675745.

In summary, the following typical features of the disclosure should be noted in particular: The disclosure relates to a spectacle lens 16, 18 which has a body 36. The body 36 contains at least one diffraction structure 38, 40 which is made to extend in the body 36 on a body surface 42, 44. The diffraction structure 38 is formed by a spatial modulation of the refractive index n(x, y) dependent on the location 54,56 in the body surface 42, 44. The spatial modulation of the refractive index n(x, y) in the body 36 is continuous. The continuity of the spatial modulation of the refractive index n(x, y) m the body 36 typically exists over a contiguous area B of the body surface 42, for the diameter D of which, defined as the supremum of the metric distance d(x, y) between two arbitrary points x, y arranged in the area of the body surface, with

D:=sup{(d(x, y): x, y ∈ B},

the following applies:
D≥1 mm, typically D≥10 mm, particularly typically D≥20 mm.

The diffraction structure converts a spherical light wave which originates from a point 14, 14′ on an object surface 28 into a light wave which projects an image of the point 14, 14′ on the object surface 28 onto an image point 15, 15′ lying in an image surface 28′ that is optically conjugate to the object surface 28.

Clause 1: Typical Features of the Disclosure:
1. A spectacle lens (16, 18)
ii) with a body (36),
iii) which contains at least one diffraction structure (38),
iv) which is made to extend on a body surface (42), and
v) which is formed by a spatial modulation of the refractive index n(x, y) dependent on the location (54, 56) in the body surface (42).
vi) characterized in that
vii) the spatial modulation of the refractive index n(x, y) in the body (36) is continuous and the diffraction structure converts a spherical light wave which originates from a point (14, 14′) on an object surface (28) into a light wave which projects an image of the point (14, 14′) on the object surface (28) onto an image point (15, 15′) lying in an image surface (28′) that is optically conjugate to the object surface (28).

Clause 2. The spectacle lens according to clause 1, characterized in that the spatial modulation of the refractive index n(x, y) is continuous over a contiguous area B of the body surface (42), for the diameter D of which, defined as the supremum of the metric distance d(x,y) between two arbitrary points x, y arranged in the area of the body surface (42), with

D:=sup{d(x, y): x, y ∈ B},
i) the following applies:
   D≥1 mm, typically D≥10 mm, particularly typically D≥20 mm,
ii) wherein the diffraction structure in the area B converts a spherical light wave which originates from a point (14, 14′) on an object surface (28) into a light wave which projects an image of the point (14, 14′) on the object surface (28) onto an image point (15, 15′) lying in an image surface (28′) that is optically conjugate to the object surface (28).

Clause 3. The spectacle lens according to clause 1 or 2, characterized in that the at least one diffraction structure (38) is a hologram of at least a first reference wave W₁₁ and a second reference wave W₁₂.

Clause 4. The spectacle lens according to clause 3, characterized in that the hologram of the diffraction structure (38) is a hologram of two pairs of reference waves (W₁₁, W₁₂) or a number of pairs of reference waves Pᵢ (Wᵢ₁, Wᵢ₂, i=1, 2, 3 . . . .

Clause 5. The spectacle lens according to clause 3 or clause 4, characterized in that the hologram is formed as an optical grating which has a local grating period vector

\vec{Λ_{G38}}:=Λₓ\vec{eₓ}+Λ_{y}\vec{e_{y}}+Λ_{z}\vec{e_{z}}
i) and a local grating vector

$$\vec{{k}_{G 38}} := \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}}$$

ii with a mating vector amount

$$\vert \vec{{k}_{G 38}} \vert := \vert \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}} \vert .$$

Clause 6. The spectacle leas according to clause 5, characterized in that, for the grating vector amount |\vec{k_{G38}}| of the optical grating, the following applies: 2.0 μm≤2π/|\vec{k_{G38}}|≤2.8 μm.

Clause 7. The spectacle lens according to clause 5 or 6, characterized in that the grating vector amount |\vec{k_{G38}}| is globally constant.

Clause 8. The spectacle lens according to clause 5 or 6, characterized in that, for the grating vector amount, the following applies:
i) |\vec{k_{G38}}|:=F₃₈ (x, y),
ii) where F₃₈(x, y) is a scalar function dependent on the location (54, 56) in the body surface (42,44).

Clause 9. The spectacle lens according to clause 8, characterized in that the grating vector \vec{k_{G38}} has for at least one viewing direction (30,30′) of the observer (24) a grating vector amount |\vec{k_{G38}}| that optimizes an imaging aberration of the image point (15,15′).

Clause 10. The spectacle lens according to clause 9, characterized in that the imaging aberration corresponds to one imaging aberration or a number of imaging aberrations from the group comprising color defect, astigmatism, coma and defocus.

Clause 11. The spectacle lens according to one of clauses 5 to 10, characterized in that the grating vector \vec{k_{G38}} has for at least one viewing direction (30, 30′) of the observer (24) a grating vector amount |\vec{k_{G38}}| that optimizes a diameter of the image point (15, 15′) and/or characterized in that the grating vector \vec{k_{G38}} has for at least one viewing direction (30. 30′) of the observer (24) a grating vector amount |\vec{k_{G38}} that optimizes a diffraction efficiency η of the at least one diffraction structure (38).

Clause 12. The spectacle lens according to one of clauses 4 to 11 characterized in that the grating vector \vec{k_{G38}} has for at least one viewing direction (30. 30′) of the observer (24) a direction that optimizes an imaging aberration of the image point (15, 15′).

Clause 13. The spectacle lens according to clause 12, characterized in that the imaging aberration corresponds to one imaging aberration or a number of imaging aberrations from the group comprising color defect, astigmatism, coma and defocus.

Clause 14. The spectacle lens according to one of clauses 4 to 13, characterized in that the grating vector \vec{k_{G38}} has for at least one viewing direction (30. 30′) of the observer (24) a direction that optimizes a diameter of the image point (15, 15′).

Clause 15. The spectacle lens according to one of clauses 4 to 14, characterized in that the grating vector \vec{k_{G38}} has for at least one viewing direction (30, 30′) of the observer (24) a direction that optimizes a diffraction efficiency η of the at least one diffraction structure (38).

Clause 16. The spectacle lens according to one of clauses 4 to 15, characterized by a body (36) which is transparent or at least partially transparent to the light, wherein the diffraction structure (38) is made to extend in the body (36) on a body surface (42) and, when observing the object surface (28), can be passed through by a line of sight ray (31, 31′) that corresponds to different viewing directions (30) of an eye (32, 34) of an observer (24) having a center of rotation of the eye (50) and a pupil center (51) and extends through the center of rotation of the eye (50) and the pupil center (51) as well as the point (14, 14′) on the object surface (28).

Clause 17. The spectacle lens according to clause 16, characterized by a different optical effect for different viewing directions (30, 30′)

Clause 18. The spectacle lens according to clause 16 or 17, characterized in that the first reference wave W₁₁ is a spherical light wave emitted from the center of rotation (50) of the eye (34) of the observer (24).

Clause 19. The spectacle lens according to one of clauses 16 to 18, characterized in that at each place that can be passed through by the line of sight ray (31, 31′) on a side of the diffraction structure (38) facing the observer (24), the following applies for the wavefront vector \vec{k_{W11}} of the first reference wave W₁₁ and the wavefront vector \vec{k_{W12}} of the second reference wave W₁₂ and also the grating vector \vec{k_{G38}} of the hologram:

\vec{k_{W11}}=\vec{k_{W12}}−\vec{k_{G38}}

Clause 20. The spectacle lens according to one of clauses 1 to 19 characterized by at least one further diffraction structure (40), which diffracts light diffracted into a first order of diffraction O1 by the at least one diffraction structure (38) into an order of diffraction O2, for which the following applies: |O1|=|O2| and sign(O1)=−sign(O2).

Clause 21. The spectacle lens according to clause 20, characterized in that the at least one further diffraction structure (40) is made to extend on a further body surface (44), which may coincide with the first body surface (42) and is formed by a spatial modulation of the refractive index n(x, y) dependent on the location (54, 56) in the body surface (42, 44).

Clause 22. The spectacle lens according to clause 21, characterized in that the at least one further diffraction structure (40) is a hologram of at least one further first reference wave W₂₁ and a further second reference wave W₂₂, wherein the further first reference wave W₂₁ is the first reference wave W₁₁ diffracted by means of the at least one diffraction structure (38) or the second reference wave W₁₂ diffracted by means of the at least one diffraction structure (38).

Clause 23. The spectacle lens according to clause 22, characterized in that the hologram is formed as a further optical grating which has a local grating period vector

\vec{Λ_{G40}}:=Λₓ\vec{eₓ}+Λ_{y}\vec{e_{y}}+Λ_{z}\vec{e_{z}}
i) and a local grating vector

$$\vec{{k}_{G 40}} := \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}}$$

ii) with a grating vector amount

$$\vec{\vert {k}_{G 40}} \vert := \vert \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}} \vert .$$

Clause 24. The spectacle leas according to clause 23, characterized in that, for the grating vector amount |\vec{k_{G40}}| of the further optical grating, the following applies: 2.0 μm≤2π/|\vec{k_{G40}}|≤2.8 μm.

Clause 25. The spectacle lens according to clause 23 or 24, characterized in that the grating vector amount |\vec{k_{G40}}| is globally constant.

Clause 26. The spectacle lens according to clause 23 or 24, characterized in that, for the grating vector amount, the following applies:
i) |\vec{k_{G40}}|:=F₄₀ (x, y),
ii) where F₄₀ (x, y) is a scalar function dependent on the location (54, 56) in the body surface (42, 44).

Clause 27. The spectacle lens according to clause 26, characterized in that the grating vector \vec{k_{G40}} has for at least one viewing direction (30, 30′) of the observer (24) a grating vector amount |\vec{k_{G40}}| that optimizes an imaging aberration of the image point (15, 15′).

Clause 28. The spectacle lens according to clause 27, characterized in that the imaging aberration corresponds to one imaging aberration or a number of imaging aberrations from the group comprising color defect, astigmatism, coma and defocus.

Clause 29. The spectacle lens according to one of clauses 23 to 28, characterized in that the grating vector \vec{k_{G40}} has for at least one viewing direction (30, 30′) of the observer (24) a grating vector amount |\vec{k_{G40}} that optimizes a diameter of the image point (15, 15′).

Clause 30. The spectacle lens according to one of clauses 23 to 29, characterized in that the grating vector \vec{k_{G40}} has for at least one viewing direction (30. 30′) of the observer (24) a grating vector amount |\vec{k_{G40}}| that optimizes a diffraction efficiency η of the at least one diffraction structure (38).

Clause 31. The spectacle lens according to one of clauses 23 to 30, characterized in that the grating vector \vec{k_{G40}} has for at least one viewing direction (30, 30′) of the observer (24) a direction that optimizes an imaging aberration of the image point (15, 15′).

Clause 32. The spectacle lens according to clause 31, characterized in that the imaging aberration corresponds to one imaging aberration or a number of imaging aberrations from the group comprising color defect, astigmatism, coma and defocus.

Clause 33. The spectacle lens according to one of clauses 23 to 32, characterized m that the grating vector \vec{k_{G40}} has for at least one viewing direction ( 30, 30′) of the observer (24) a direction that optimizes a diameter of the image point (15, 15′).

Clause 34. The spectacle lens according to one of clauses 23 to 33, characterized in that the grating vector \vec{k_{G40}} has for at least one viewing direction (30, 30′) of the observer (24) a diffraction efficiency η of the direction that optimizes at least one diffraction structure (38).

Clause 35. The spectacle leas according to one of clauses 23 to 34, characterized in that at each place that can be passed through by the line of sight ray (31, 31′) on a side of the further diffraction structure (38) facing the observer (24), the following applies for the wavefront vector \vec{k_{W21}} of the further first reference wave W₂₁ and the wavefront vector \vec{k_{W22}} of the further second reference wave W₂₂ and also the grating vector \vec{k_{G40}} of the hologram;

\vec{k_{W12}}=\vec{k_{W22}}−\vec{k_{G40}}

Clause 36. The spectacle lens according to one of clauses 22 to 35, characterized in that the hologram of the at least one further diffraction structure (40) is a hologram of two pairs of reference waves (W₂₁, W₂₂) or a number of pairs of reference waves Pᵢ (Wᵢ₁, Wᵢ₂), i=1, 2, 3 . . . .

Clause 37. The spectacle lens according to one of clauses 1 to 19, characterized by a phase object (20, 22) which contains the at least one diffraction structure (38), wherein the phase object (20, 22) directs the light incident on a side of the spectacle lens (16, 18) facing away from the observer (24) with respect to the surface normal (48) at an angle of incidence α to a surface normal (48) of the spectacle lens front surface (46) from a point (14, 14′) on an object surface (28) in a direction dependent on the wavelength k of the light and on the angle of incidence α of the light.

Clause 38. The spectacle lens according to one of clauses 20 to 36, characterized by a phase object (20, 22) which contains the at least one diffraction structure (38) and the at least one further diffraction structure (40), wherein the phase object (20, 22) directs the light incident on a side of the spectacle lens (16, 18) facing away from the observer (24) with respect to the surface normal (48) at an angle of incidence α to a surface normal (48) of the spectacle lens front surface (46) from a point (14, 14′) on an object surface (28) in a direction dependent on the wavelength λ of the light and on the angle of incidence α of the light.

Clause 39. The spectacle lens according to clause 1 or 2, characterized in that the body (36) has a phase object (20, 22) which contains the at least one diffraction structure (38), wherein the phase object (20, 22) and the body (36) directs the light incident on a side of the spectacle lens (16, 18) facing away from the observer (24) with respect to the surface normal (48) at an angle of incidence α₁ to a surface normal (48) of the spectacle lens front surface (46) from a point (14, 14′) on an object surface (28) in a direction dependent on the wavelength λ of the light and on the angle of incidence at of the light,
i) wherein, for the light incident on a side of the spectacle lens (16, 18) facing away from the observer (24) with respect to the surface normal (48) at the angle of incidence α₁ to the surface normal (48) of the spectacle lens front surface (46) from the point (14, 14′) on the object surface (28), the body (36) is a refractive body with a refractive dispersion D_{ref.1} with

$${D}_{ref .1} := \frac{\partial {α}_{2}}{\partial λ} = \frac{\partial }{\partial λ} asin ( \frac{{n}_{1} ( λ ) sin {α}_{1}}{{n}_{2} ( λ )} ) ,$$

i) wherein, for the light exiting on a side of the spectacle lens (16, 18) facing the observer (24) with respect to the surface normal (48) at the exit angle α₆ from the point (14, 14′) on the object surface (28), the body (36) is a refractive body with a refractive dispersion D_{ref.2} with

$${D}_{ref .2} := \frac{\partial {α}_{6}}{\partial λ} = \frac{\partial }{\partial λ} asin ( \frac{{n}_{2} ( λ ) sin {α}_{6}}{{n}_{3} ( λ )} ) ,$$

ii) where n₁(λ) is the refractive index, generally dependent on the wavelength λ, of an optical medium for the light arranged between the object surface (28) and the body (36),
iii) where n₂(λ) is the refractive index, generally dependent on the wavelength λ, of the body (36) for the light,
iv) where n₃(λ) is the refractive index, generally dependent on the wavelength λ, of an optical medium for the light arranged between the pupil (52) and the body (36),
v) wherein the diffraction structure (38) has for the light incident on a side of the spectacle lens (16, 18) facing away from the observer (24) with respect to the surface normal (48) at the angle of incidence α₁ to the surface normal (48) of the spectacle lens front surface (46) from the point (14, 14′) on the object surface (28) a diffractive dispersion D_{diff.1} that compensates at least partially for the refractive dispersion D_{ref.}:=D_{ref.1}+D_{ref.2} of the body (36) with

$${D}_{diff .1} := \frac{\partial {α}_{4}}{\partial λ} = \frac{m}{{Λ}_{proj .38} cos {α}_{4}} ,$$

vi) where α₄ is a deflection angle, related to a surface normal (48) at a place of the body surface (42) on which the diffraction structure (38) is made to extend that is passed through by the light incident on the spectacle lens front surface (46) at the angle of incidence α₁ to the surface normal (48) of the spectacle lens front surface (46) from the point (14, 14′) on the object surface (28), for the light incident on the spectacle lens front surface (46) at the angle of incidence α₁ to the surface normal (48) of the spectacle lens front surface (46) from the point (14, 14′) on the object surface (28).
vii) wherein the diffraction structure (38) is a hologram of at least a first reference wave W₁₁ and a second reference wave W₁₂, which is formed as an optical grating that has a local grating period vector

\vec{Λ_{G38}}:=Λ₃₈ₓ\vec{eₓ}+Λ_{38y}\vec{e_{y}}+Λ_{38z}\vec{e_{z}}
viii) and a local grating vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

ix) a grating vector amount

$$\vert \vec{{k}_{G 38}} \vert := \vert \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}} \vert$$

x) and
xi) where Λ_{proj.38} is the grating period of the projection of the vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

xii) onto the body surface (42) with

$${Λ}_{proj .38} := \frac{2 π}{\vert \frac{2 π}{{Λ}_{38 x}} \vec{{e}_{x}} + \frac{2 π}{{Λ}_{38 y}} \vec{{e}_{y}} \vert} .$$

Clause 40. The spectacle lens according to clause 39, characterized in that the following applies:
i) sign(D_{ref.1}+D_{ref.2})=−sign(D_{diff.1})

Clause 41. The spectacle lens according to clause 39 or clause 40, characterized by
i) at least one further diffraction structure (40), which diffracts light diffracted into a first order of diffraction O1 by the at least one diffraction structure (38) into an order of diffraction O2, for which the following applies: |O1|=|O2| and sign(O1)=−sign(O2).
ii) wherein the at least one further diffraction structure (40) is made to extend on a further body surface (44), which may coincide with the first body surface (42) and is formed by a spatial modulation of the refractive index n(x, y) dependent on the location (54, 56) in the body surface (42, 44),
iii) wherein the at least one further diffraction structure (40) is a hologram of at least one further first reference wave W₂₁ and a further second reference wave W₂₂, wherein the further first reference wave W₂₁ is the first reference wave W₁₁ diffracted by means of the at least one diffraction structure (38) or the second reference wave W₁₂ diffracted by means of the at least one diffraction structure (38),
iv) wherein the hologram of the further diffraction structure (40) is formed as a further optical grating that has a local grating period vector

\vec{Λ_{G40}}:=Λ₄₀ₓ\vec{eₓ}+Λ_{40y}\vec{e_{y}}+Λ_{40z}\vec{e_{z}}
v) and a local grating vector

$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

vi) with a grating vector amount

$$\vert \vec{{k}_{G 40}} \vert := \vert \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}} \vert$$

vii) hat,
viii) wherein, for the light incident on a side of the spectacle lens (16, 18) facing away from the observer (24) with respect to the surface normal (48) at the angle of incidence α₁ to the surface normal (48) of the spectacle lens front surface (46) from the point (14, 14′) on the object surface (28) and then refracted to the angle α₂ with respect to the surface normal (48), the at least one further diffraction structure (40) has a diffractive dispersion D_{diff.2} with

$${D}_{diff .2} := \frac{\partial {α}_{3}}{\partial λ} = \frac{m}{{Λ}_{proj .40} cos {α}_{3}} ,$$

ix) where Λ_{proj.40} is the grating period of the projection of the grating vector of the further optical grating

$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

x) onto the further body surface (44) with

$${Λ}_{proj .40} := \frac{2 π}{\vert \frac{2 π}{{Λ}_{40 x}} \vec{{e}_{x}} + \frac{2 π}{{Λ}_{40 y}} \vec{{e}_{y}} \vert}$$

xi) and where α₃ is a deflection angle, related to a surface normal (48) at a place of the further body surface (44) on which the further diffraction structure (40) is made to extend that is passed through by the light incident on the spectacle lens front surface (46) at the angle of incidence α₁ to the surface normal (48) of the spectacle lens front surface (46) from the point (14, 14′) on the object surface (28), for the light incident on the spectacle lens front surface at the angle of incidence α₁ to the surface normal (48) of the spectacle lens front surface (46) from the point (14, 14′) on the object surface (28).

Clause 42. The spectacle lens according to clause 41, characterized in that the following applies:
i) sign(D_{ref.1}+D_{ref.2})=−sign(D_{diff.1}+D_{diff.2})

Clause 43. The spectacle lens according to clause 42, characterized in that the following applies:

i) |D_{ref.1}+D_{ref.1}+D_{diff.1}+D_{diff/1}|≤S.
ii) with S=0.72 cm/m, typically S=0.36 cm/m, particularly typically S=0.12 cm/m.

Clause 44. The spectacle lens according to clause 43, characterized in that the grating vector \vec{k_{G38}} of the diffraction structure (38) and the grating vector \vec{k_{G40}} of the further diffraction structure (40) have for at least one viewing direction (30) of the observer (24) grating vector amounts |\vec{k_{G38}}|, |\vec{k_{G40}}| that optimize a cost function K, where the cost function K contains a cost function term Ki with:
i) Kᵢ:=K_{iGP1}+K_{iGP2}+K_{iGP2}+K_{iSPH}+K_{iFF}
ii) with

$${K}_{iGP 1} := {a}_{1} ( \vert \frac{2 π}{\vert \vec{{k}_{G 38}} \vert} - 2.4 µm \vert - 0.4 µm )$$

at the location (54) passed through by the viewing direction (30) on the body surface (42) on which the diffraction structure (38) is made to extend,
iii) with

$${K}_{iGP 2} := {a}_{2} ( \vert \frac{2 π}{\vert \vec{{k}_{G 40}} \vert} - 2.4 µm \vert - 0.4 µm )$$

at the location (56) passed through by the viewing direction (30) on the further body surface (42) on which the further diffraction structure (40) is made to extend,
iv) with K_{iSPH}:=a₂(SPHᵢₛₜ−SPHₛₒₗₗ) as a spherical imaging aberration of the point (14) on the object surface (28).
v) with K_{iAST}:=α₄(ASTᵢₛₜ−ASTₛₒₗₗ) as an astigmatic imaging aberration of the point (14) on the object surface (28),
vi) with K_{iFF}=a₅(FFᵢₛₜ−FFₛₒₗₗ) as a chromatic imaging aberration of the point (14) on the object surface (28),
vii) where the coefficients aₓ can be freely selected with x=1, 2, 3, 4, 5.

Clause 45. The spectacle lens according to clause 43 characterized in that the grating vector \vec{k_{G38}} of the diffraction structure (38) and the grating vector \vec{k_{G40}} of the further diffraction structure (40) have for a large number of viewing directions i of the observer (24) grating vector amounts |\vec{k_{G38}}|, |\vec{k_{G40}}| that optimize a cost function K, where the cost function K contains a cost function term \tilde{K}: with

\tilde{K}:=Ki
i) where
ii) Kᵢ=K_{iGP1}+K_{iGP2}+K_{iGP2}+K_{iSPH}+K_{iFF}
iii) with

$${K}_{iGP 1} := {a}_{1} ( \vert \frac{2 π}{\vert \vec{{k}_{G 38}} \vert} - 2.4 µm \vert - 0.4 µm )$$

at the location (54) passed through by the viewing direction i on the body surface (42) on which the diffraction structure (38) is made to extend.
iv) with

$${K}_{iGP 2} := {a}_{2} ( \vert \frac{2 π}{\vert \vec{{k}_{G 40}} \vert} - 2.4 µm \vert - 0.4 µm )$$

at the location (56) passed through by the viewing direction i on the further body surface (42) on which the further diffraction structure (40) is made to extend,
v) with K_{iSPH}:=aᵢ₃(SPHᵢₛₜ−SPHₛₒₗₗ) as a spherical imaging aberration of the point (14) on the object surface (28),
vi) with K_{iAST}:=aᵢ₄(ASTᵢₛₜ−ASTₛₒₗₗ) an astigmatic imaging aberration of the point (14) on the object surface (28).
vii) with K_{iFF}=aᵢ₅(FFᵢₛₜ−FFₛₒₗₗ) as a chromatic imaging aberration of the point (14) on the object surface (28).
viii) where the coefficients aᵢₓ can be freely selected with x=1, 2, 3, 4, 5.

Clause 46. The spectacle lens according to clause 45, characterized in that a geometry of the body (36), in particular a center thickness of the body (36) and/or a front radius of the body (36) and/or a back radius of the body (36), has values that optimize the cost function K.

Clause 47. The spectacle lens according to clause 46, characterized in that the geometry of the body has coefficients describing an aspherical shape or a free-surface shape of the spectacle lens front surface (46) and/or the spectacle lens rear surface.

Clause 48. The spectacle lens according to one of clauses 45 to 47, characterized by a positive refractive power, where the cost function K contains a cost function K_{Rand} with: K_{Rand}:=aₓ(RDᵢₛₜ−RDₛₒₗₗ).
i) where RDᵢₛₜ is an actual value tor the center thickness of the spectacle lens and where RDₛₒₗₗ is a target value for the center thickness of the spectacle lens.

Clause 49. The spectacle lens according to one of clauses 45 to 47, characterized by a negative refractive power, where the cost function K contains a cost function term K_{Rand} with: K_{Rand}:= ₓ(RDᵢₛₜ−RDₛₒₗₗ), where RDᵢₛₜ is an actual value for the edge thickness of the spectacle lens and where RDₛₒₗₗ is a target value for the edge thickness of the spectacle lens.

Clause 50. A method for determining the design of a spectacle lens (16, 18) with a body (36),
i) in which a geometry and an object surface (28) and also an optical transfer function is specified for the spectacle lens (16, 18),
ii) wherein a phase object (20, 22) which directs the light incident on a side of the spectacle lens (16, 18) facing away from the observer (24) at an angle of incidence α to a surface normal \vec{n} of the spectacle lens front surface (46) in a direction dependent on the wavelength λ of the light and on the angle of incidence α of the light is calculated for the specified optical transfer function and the specified geometry.
iii) wherein the phase object (20, 22) contains at least one diffraction structure (38, 40)
iv) which is made to extend in the body (36) on a body surface (42, 44) and, when observing an object surface (28), can be passed through by a line of sight ray (31, 31′) that corresponds to a viewing direction (30) of an eye (32, 34) of the observer (24) having a center of rotation of the eye (50) and a pupil center (51) and extends through the center of rotation of the eye (50) and the pupil center (51) as well as the point (14, 14′) on the object surface (28),
v) which is formed by a spatial modulation of the refractive index n(x, y) that is dependent on the location (x, y) in the body surface (42, 44) passed through by the viewing direction (30),
vi) characterized in that
vii) the spatial modulation of the refractive index n(x, y) in the body (36) is continuous and the diffraction structure converts a spherical light wave which originates from a point (14, 14′) on an object surface (28) into a light wave which projects an image of the point (14, 14′) on the object surface (28) onto an image point (15, 15′) lying in an image surface (28′) that is optically conjugate to the object surface (28),
viii) wherein the diffraction structure (38, 40) converts a spherical light wave which originates from a point on the object surface (28) that is passed through by the viewing direction into a light wave, running along the viewing direction (30, 30), which projects an image of the point on the object surface (28) onto an image point in the eye (32, 34) of the observer (24) lying in an image surface (28) that is optically conjugate to the object surface (28).

Clause 51. The method according to clause 50, characterized in that the spatial modulation of the refractive index n(x, y) forming the at least one diffraction structure (38, 40) is continuous in the area of the body (36) that can be passed through by a viewing direction over a contiguous area B of the body surface (42), for the diameter D of which, defined as the supremum of the metric distance d(x,y) between two arbitrary points x, y arranged in the area of the body surface (42), with

D:=sup{d(x, y): x, y ∈ B},
i) the following applies:
   D≥1 mm, typically D≥1.0 mm, particularly typically D≥20 mm.

Clause 52. The method according to clause 50 or 51, characterized in that the at least one diffraction structure (38) is a hologram of at least a first reference wave W₁₁ and a second reference wave W₁₂, wherein the hologram is formed as an optical grating that has a local grating vector

\vec{Λ_{G38}}:=Λₓ\vec{eₓ}+Λ_{y}\vec{e_{y}}+Λ_{z}\vec{e_{z}}
i) and a local grating vector

$$\vec{{k}_{G 38}} := \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}}$$

ii) with a grating vector amount

$$\vert \vec{{k}_{G 38}} \vert := \vert \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}} \vert .$$

Clause 53. The method according to clause 52, characterized in that, for the grating vector amount |\vec{k_{G38}}| of the optical grating, the following applies: 2.0 μm'2π/|\vec{k_{G38}}|≤2.8 μm.

Clause 54. The method according to one of clauses 50 to 52, characterized in that the grating vector amount |\vec{k_{G38}}| is globally constant.

Clause 55. The method according to one of clauses 50 to 52, characterized in that, for the grating vector amount, the following applies:
i) |\vec{k_{G38}}|:=F₃₈(x, y),
ii) where F₃₈(x, y) is a scalar function dependent on the location (54, 56) in the body surface (42, 44).

Clause 56. The method according to clause 55, characterized in that the grating vector amount |\vec{k_{G38}}| of the grating vector \vec{k_{G38}} is optimized for at least one viewing direction (30, 30′) of the observer (24) in order to optimize an imaging aberration of the image point in the eye (32, 34) of the observer (24).

Clause 57. The method according to clause 56, characterized in that the imaging aberration corresponds to one imaging aberration or a number of imaging aberrations from the group comprising color defect, astigmatism, coma.

Clause 58. The method according to clause 56 or 57, characterized in that the grating vector amount |\vec{k_{G38}}| of the grating vector \vec{k_{G38}} is optimized for at least one viewing direction (30, 30′) of the observer (24) in order to minimize a diameter of the image point in the eye (32, 34) of the observer (24) and/or characterized in that the grating vector amount |\vec{k_{G38}}| of the grating vector \vec{k_{G38}} is optimized for at least one viewing direction (30, 30′) of the observer (24) in order to maximize a diffraction efficiency η of the at least one diffraction structure.

Clause 59. The method according to one of clauses 50 to 58, characterized in that the direction of the grating vector \vec{k_{G38}} is optimized for at least one viewing direction (30, 30′) of the observer (24) in order to optimize an imaging aberration of the image point in the eye (32, 34) of the observer (24).

Clause 60. The method according to clause 59, characterized in that the imaging aberration corresponds to one imaging aberration or a number of imaging aberrations from the group comprising color defect, astigmatism, coma.

Clause 61. The method according to one of clauses 50 to 60, characterized in that the grating vector \vec{k_{G38}} is optimized for at least one viewing direction (30, 30′) of the observer (24) in order to minimize a diameter of the image point in the eye (32, 34) of the observer (24).

Clause 62. The method according to one of clauses 50 to 61, characterized in that the grating vector \vec{k_{G38}} is optimized for at least one viewing direction (30, 30′) of the observer (24) in order to maximize a diffraction efficiency η of the at least one diffraction structure.

Clause 63. The method according to clause 50, characterized in that the body (36) has a phase object (20, 22) which contains the at least one diffraction structure (38), wherein the phase object (20, 22) and the body (36) directs the light incident on a side of the spectacle lens (16, 18) facing away from the observer (24) with respect to the surface normal (48) at an angle of incidence α₁ to a surface normal (48) of the spectacle lens front surface (46) from a point (14, 14′) on an object surface (28) in a direction dependent on the wavelength λ of the light and on the angle of incidence α₁ of the light,
i) wherein, for the light incident on a side of the spectacle lens (16, 18) facing away from the observer (24) with respect to the surface normal (48) at the angle of incidence α₁ to the surface normal (48) of the spectacle lens front surface (46) from the point (14, 14′) on the object surface (28), the body (36) is a refractive body with a refractive dispersion D_{ref.1} with

$${D}_{ref .1} := \frac{\partial {α}_{2}}{\partial λ} = \frac{\partial }{\partial λ} asin ( \frac{{n}_{1} ( λ ) sin {α}_{1}}{{n}_{2} ( λ )} ) ,$$

ii) wherein, for the light exiting on a side of the spectacle lens (16, 18) facing the observer (24) with respect to the surface normal (48) at the exit angle α₆ from the point (14, 14′) on the object surface (28), the body (36) is a refractive body with a refractive dispersion D_{ref.2} with

$${D}_{ref .2} := \frac{\partial {α}_{6}}{\partial λ} = \frac{\partial }{\partial λ} asin ( \frac{{n}_{2} ( λ ) sin {α}_{6}}{{n}_{3} ( λ )} ) ,$$

iii) where n₁(λ) is the refractive index, generally dependent on the wavelength λ, of an optical medium for the light arranged between the object surface (28) and the body (36),
iv) where n₂(λ) as the refractive index, generally dependent on the wavelength λ, of the body (36) for the light,
v) where n₃(λ) is the refractive index, generally dependent on the wavelength λ, of an optical medium for the light arranged between the pupil (52) and the body (36),
vi) wherein the diffraction structure (38) has for the light incident on a side of the spectacle lens (16, 18) facing away from the observer (24) with respect to the surface normal (48) at the angle of incidence α₁ to the surface normal (48) of the spectacle lens front surface (46) from the point (14, 14′) on the object surface (28) a diffractive dispersion D_{diff.1} that compensates at least partially for the refractive dispersion D_{ref.}:=D_{ref.1}+D_{ref.2} of the body (36) with

$$vii ) {D}_{diff .1} := \frac{\partial {α}_{4}}{\partial λ} = \frac{m}{{Λ}_{proj .38} cos {α}_{4}} , \qquad$$

viii) where α₄ is a deflection angle, related to a surface normal (48) at a place of the body surface (42) on which the diffraction structure (38) is made to extend that is passed through by the light incident on the spectacle lens front surface at the angle of incidence α₁ to the surface normal (48) of the spectacle lens front surface (46) from the point (14, 14′) on the object surface (28), for the light incident on the spectacle lens front surface at the angle of incidence α₁ to the surface normal (48) of the spectacle lens front surface (46) from the point (14, 14′) on the object surface (28),
ix) wherein the diffraction structure (38) is a hologram of at least a first reference wave W₁₁ and a second reference wave W₁₂, which is formed as an optical grating that has a local grating period vector

\vec{Λ_{G38}}:=Λ₃₈ₓ\vec{eₓ}+Λ_{38y}\vec{e_{y}}+79 _{38z}\vec{e_{z}}
x) and a local grating vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

xi) with a grating vector amount,

$$\vert \vec{{k}_{G 38}} \vert := \vert \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}} \vert$$

xii) and
xiii) where Λ_{proj.38} is the grating period of the projection of the grating vector

$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$

xiv) onto the body surface (42) with

$${Λ}_{proj .38} := \frac{2 π}{\vert \frac{2 π}{{Λ}_{38 x}} \vec{{e}_{x}} + \frac{2 π}{{Λ}_{38 y}} \vec{{e}_{y}} \vert} .$$

Clause 64. The method according to clause 63, characterized in that the following applies:
i) sign(D_{ref.1}+D_{ref.2})=−sign(D_{diff.1})

Clause 65. The method according to clause 63 or clause 64, characterized by
i) at least one further diffraction structure (40), which diffracts light diffracted into a first order of diffraction O1 by the at least one diffraction structure (38) into an order of diffraction O2, for which the following applies |O1|=|O2| and sign (O1)=−sign(O2),
ii) wherein the at least one further diffraction structure (40) is made to extend on a further body surface (44), which may coincide with the first body surface (42) and is formed by a spatial modulation of the refractive index n(x, y) dependent on the location (54, 56) in the body surface (42, 44),
iii) wherein the at least one further diffraction structure (40) is a hologram of at least one further first reference wave W₂₁ and a further second reference wave W₂₂, wherein the further first reference wave W₂₁ is the first reference wave W₁₁ diffracted by means of the at least one diffraction structure (38) or the second reference wave W₁₂ diffracted by means of the at least one diffraction structure (38),
iv) wherein the hologram of the further diffraction structure (40) is formed as a further optical grating that has a local grating period vector

\vec{Λ_{G40}}:=Λ₄₀ₓ\vec{eₓ}+Λ_{40y}\vec{e_{y}}+Λ_{40z}\vec{e_{z}}
v) and a local grating vector

$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

vi) with a grating vector amount

$$\vert \vec{{k}_{G 40}} \vert := \vert \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}} \vert$$

vii) hat,
viii) wherein, for the light incident on a side of the spectacle lens (16, 18) facing away from the observer (24) with respect to the surface normal (48) at the angle of incidence α₁ to the surface normal (48) of the spectacle lens front surface (46) from the point (14, 14′) on the object surface (28) and then refracted to the angle α₂ with respect to the surface normal (48), the at least one further diffraction structure (40) has a diffractive dispersion D_{diff.2} with

$${D}_{diff .2} := \frac{\partial {α}_{3}}{\partial λ} = \frac{m}{{Λ}_{proj .40} cos {α}_{3}} ,$$

ix) where Λ_{proj.40} is the grating period of the projection of the grating vector of the further optical grating

$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$

x) onto the further body surface (44) with

$${Λ}_{proj .40} := \frac{2 π}{\vert \frac{2 π}{{Λ}_{40 x}} \vec{{e}_{x}} + \frac{2 π}{{Λ}_{40 y}} \vec{{e}_{y}} \vert}$$

xi) and wherein α₃ is a deflection angle, related to a surface normal (48) at a place of the further body surface (44) on which the further diffraction structure (40) is made to extend that is passed through by the light incident on the spectacle lens boot surface at the angle of incidence α₁ to the surface normal (48) of the spectacle lens front surface (46) from the point (14, 14′) on the object surface (28), for the light incident on the spectacle lens front surface (46) at the angle of incidence α₁ to the surface normal (48) of the spectacle lens front surface (46) from the point (14, 14′) on the object surface (28).

Clause 66. The method according to clause 65, characterized in that the following applies:
i) sign(D_{ref.1}+D_{ref.2})=−sign(D_{diff.1}+D_{diff.2})

Clause 67. The method according to clause 66 characterized in that the following applies:
i) |D_{ref.1}+D_{ref.1}+D_{diff.1}+D_{diff.1}|≤S.
ii) with S=0.72 cm/m, typically S=0.36 cm/m, particularly typically S=0.12 cm/m.

Clause 68. The method according to clause 67, characterized in that the grating vector \vec{k_{G38}} of the diffraction structure (38) and the grating vector \vec{k_{G40}} of the further diffraction structure (40) have for at least one viewing direction (30) of the observer (24) grating vector amounts |\vec{k_{G38}}|, |\vec{k_{G40}}| which are determined by optimizing a cost function K, where the cost function K contains a cost function term Ki with:
i) Kᵢ:=K_{iGP1}+K_{iGP2}+K_{iGP3}+K_{iSPH}+K_{iFF}
ii) with

$${K}_{iGP 1} := {a}_{1} ( \vert \frac{2 π}{\vert \vec{{k}_{G 38}} \vert} - 2.4 µm \vert - 0.4 µm )$$

at the location (54) passed through by the viewing direction (30) on the body surface (42) on which the diffraction structure (38) is made to extend.
iii) with

$${K}_{iGP 2} := {a}_{2} ( \vert \frac{2 π}{\vert \vec{{k}_{G 40}} \vert} - 2.4 µm \vert - 0.4 µm )$$

at the location (56) passed through by the viewing direction (30) on the further body surface (42) on which the further diffraction structure (40) is made to extend.
iv) with K_{iSPH}:=a₃(SPHᵢₛₜ−SPHₛₒₗₗ) as a spherical imaging aberration of the point (14) on the object surface (28),
v) with K_{iAST}:=a₄(ASTᵢₛₜ−ASTₛₒₗₗ) as an astigmatic imaging aberration of the point (14) on the object surface (28),
vi) with K_{iFF}=a₅(FFᵢₛₜ−FFₛₒₗₗ) as a chromatic imaging aberration of the point (14) on the object surface (28),
vii) where the coefficients aₓ can be freely selected with x=1, 2, 3, 4, 5.

Clause 69. The method according to clause 67 characterized in that the grating vector \vec{k_{G38}} of the diffraction structure (38) and the grating vector \vec{k_{G40}} of the further diffraction structure (40) have for a large number of viewing directions i of the observer (24) grating vector amounts |\vec{k_{G38}}|, |\vec{k_{G40}}| which are determined by optimizing a cost function K, the cost function K containing a cost function term \tilde{K} with:

\vec{K}:=ΣᵢKi
i) where
ii) Kᵢ:=K_{iGP1}+K_{iGP2}+K_{iGP2}+K_{iSPH}+K_{iFF}
iii) with

$${K}_{iGP 1} := {a}_{1} ( \vert \frac{2 π}{\vert \vec{{k}_{G 38}} \vert} - 2.4 µm \vert - 0.4 µm )$$

at the location (54) passed through by the viewing direction i on the body surface (42) on which the diffraction structure (38) is made to extend,
iv) with

$${K}_{iGP 2} := {a}_{2} ( \vert \frac{2 π}{\vert \vec{{k}_{G 40}} \vert} - 2.4 µm \vert - 0.4 µm )$$

at the location (56) passed through by the viewing direction i on the further body surface (42) on which the further diffraction structure (40) is made to extend,
v) with K_{iSPH}:=aᵢ₃(SPHᵢₛₜ−SPHₛₒₗₗ) as a spherical imaging aberration of the point (14) on the object surface (28),
vi) with K_{iAST}:=aᵢ₄(ASTᵢₛₜ−ASTₛₒₗₗ) as an astigmatic imaging aberration of the point (14) on the object surface (28),
vii) with K_{iFF}=aᵢ₅(FFᵢₛₜ−FFₛₒ₁₁) as a chromatic imaging aberration of the point (14) on the object surface (28),
viii) where the coefficients aᵢₓ can be freely selected with x=1, 2, 3, 4, 5.

Clause 70. The method according to clause 69, characterized in that a geometry of the body (36), in particular a center thickness of the body (36) and/or a front radius of the body (36) and/or a back radius of the body (36), has values that optimize the cost function K.

Clause 71. The method according to clause 70, characterized in that the geometry of the body has coefficients describing an aspherical shape or a free-surface shape of the spectacle lens front surface (46) and/or the spectacle lens rear surface.

Clause 72. The method according to one of clauses 69 to 71, characterized by a positive refractive power, where the cost function K contains a cost function term with: K_{Rand}:=aₓ(RDᵢₛₜ−RDₛₒₗₗ).
i) where RDᵢₛₜ is an actual value for the center thickness of the spectacle lens and where RDₛₒₗₗ is a target value for the center thickness of the spectacle lens.

Clause 73. The method according to one of clauses 69 to 71, characterized by a negative refractive power, where the cost function K contains a cost function term K_{Rand} with: K_{Rand}:=aₓ(RDᵢₛₜ−RDₛₒₗₗ), where RDᵢₛₜ is an actual value for the edge thickness of the spectacle lens and where RDₛₒₗₗ is a target value for the edge thickness of the spectacle lens.

Clause 74. The method according to one of clauses 68 to 73, characterized in that the grating vector \vec{k_{G38}} of the diffraction structure (38) and the grating vector \vec{k_{G40}} of the further diffraction structure (40) and also the geometry of the body (36) is optimized for at least one viewing direction (30) of the observer (24) in order to optimize at least one imaging aberration, described in the cost function K, of the viewing point in the eye (32, 34) of the observer.

Clause 75. A method for producing a spectacle lens, in particular a spectacle lens which is formed according to one of clauses 1 to 49, characterized in that a phase object (20) is generated which contains at least one hologram of a first reference wave W₁₁ generated by means of a light modulator and a second reference wave W₁₂ generated by means of a light modulator or which contains a computer-generated hologram.

Clause 76. The method according to clause 75, characterized in that the phase object is generated by exposing a film which is cemented to a glass body or a glass substrate.

### LIST OF REFERENCE SIGNS

10 Spectacles
12 Spectacle frame
14, 14′ Point on the object surface 28
15, 15′ Image point
16 Left spectacle lens
18 Right spectacle lens
18′ Further spectacle lens
20 Phase object
22 Phase object
24 Observer
28 Object surface
28′Conjugate image surface
30, 30′ Viewing direction
31, 31′ Line of sight ray
32 Left eye
34 Right eye
36 Body of the spectacle lens
38 First diffraction structure
40 Further diffraction structure
42 First body surface
44 Further body surface
46 Spectacle lens front surface
47 Modulation
48, 57, 58, 59 Surface normal
49 Amplitude
50 Center of rotation of the eye
51, 51′ Pupil center

52 Pupil
54, 54′, 56, 56′ Point/location
α, α₁ Angle of incidence
α₂, α₄, α₅, Angle
α₃ Deflection angle
α₆ Exit angle
λ Wavelength
Λ_{g} Grating constant
η Diffraction efficiency
Λₓ, Λ_{y} Λ_{z}, Λ_{G} Grating constants
Δθ Angle to a line of sight ray
n(x, y) Refractive index
B Contiguous area
d Thickness
i Viewing direction
K Cost function
n Refractive index
O1 First order of diffraction
O2 Further order of diffraction
W₁₁ First reference wave
W₁₂ Second reference wave
W₂₁ Further first reference wave
W₂₂ Further second reference wave
D_{diff.1}, D_{diff.2} Diffractive dispersion
D_{ref.1}, D_{ref.2} Refractive dispersion
Λ_{proj.40} Grating period of the projection of the grating vector

1-34. (canceled)

35. A spectacle lens for an observer, the spectacle lens comprising:
a body having at least one diffraction structure extending along a body surface,
wherein a refractive index n(x, y) of the at least one diffraction structure is spatially modulated in dependence on a location on the body surface,
wherein the spatial modulation of the refractive index n(x,y) in the body is continuous and the diffraction structure is configured to convert a spherical light wave which originates from a point on an object surface selected from a free-form surface, a plane, a curved surface, or a bent surface, the object surface being arranged on a side of the spectacle lens facing away from the observer, into a light wave which projects an image of the point on the object surface onto an image point lying in an image surface that is optically conjugate to the object surface,
wherein the spatial modulation of the refractive index n(x,y) is continuous over a contiguous area B of the body surface, for the diameter D of which, defined as the supremum of a metric distance d(x,y) between two arbitrary points x, y arranged in the area of the body surface, with
D:=sup{d(x, y): x, y ∈ B},
the following applies:
D≥10 mm,
wherein the at least one diffraction structure in the area B is configured to convert the spherical light wave which originates from the point on the object surface into the light wave which projects the image of the point on the object surface onto the image point lying on the image surface that is optically conjugate to the object surface.

36. The spectacle lens as claimed in claim 35, wherein the at least one diffraction structure is a hologram of at least a first reference wave W₁₁ and a second reference wave W₁₂.

37. The spectacle lens as claimed in claim 36, wherein the hologram of the diffraction structure is a hologram of two pairs of reference waves (W₁₁, W₁₂) or a number of pairs of reference waves Pᵢ(Wᵢ₁, Wᵢ₂), i=1, 2, 3 . . . .

38. The spectacle lens as claimed in claim 36, wherein the hologram is an optical grating which has a local grating period vector
\vec{79 _{G38}}:=Λₓ\vec{eₓ}+Λ_{y}\vec{e_{y}}+Λ_{z}\vec{e_{z}}
and a local grating vector
$$\vec{{k}_{G 38}} := \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}}$$
with a grating vector amount
$$\vec{\vert {k}_{G 38}} \vert := \vert \frac{2 π}{{Λ}_{x}} \vec{{e}_{x}} + \frac{2 π}{{Λ}_{y}} \vec{{e}_{y}} + \frac{2 π}{{Λ}_{z}} \vec{{e}_{z}} \vert$$
wherein, for the grating vector amount |\vec{k_{G38}}| of the optical grating, the following applies: 2.0 μm≤2π/|\vec{k_{G38}}|≤2.8 μm.

39. The spectacle lens as claimed in claim 37, wherein the grating vector amount |\vec{k_{G38}}| is globally constant.

40. The spectacle lens as claimed in claim 37, wherein, for the grating vector amount, the following applies:

|\vec{k_{G38}}|:=F₃₈(x, y),
where F₃₈(x, y) is a scalar function dependent on the location in the body surface.

41. The spectacle lens as claimed in claim 35, wherein the body further comprises:
a phase object which contains the at least one diffraction structure,
wherein the phase object and the body are configured to direct light incident on the side of the spectacle lens facing away from the observer with respect to the surface normal at an angle of incidence cu to a surface normal of the spectacle lens front surface from a point on an object surface in a direction dependent on the wavelength λ of the light and on the angle of incidence α₁ of the light,
wherein, for the light incident on the side of the spectacle lens facing away from the observer with respect to the surface normal at the angle of incidence α₁ to the surface normal of the spectacle lens front surface from the point on the object surface, the body is a refractive body with a refractive dispersion D_{ref.1} with
$${D}_{ref .1} := \frac{\partial {α}_{2}}{\partial λ} = \frac{\partial }{\partial λ} asin ( \frac{{n}_{1} ( λ ) sin {α}_{1}}{{n}_{2} ( λ )} ) ,$$
wherein, for the light exiting on the side of the spectacle lens facing the observer with respect to the surface normal at the exit angle α₆ from the point on the object surface, the body is a refractive body with a refractive dispersion D _{ref.2} with
$${D}_{ref .2} := \frac{\partial {α}_{6}}{\partial λ} = \frac{\partial }{\partial λ} asin ( \frac{{n}_{2} ( λ ) sin {α}_{6}}{{n}_{3} ( λ )} ) ,$$
wherein n₁(λ) is the refractive index, generally dependent on the wave sounds λ, of an optical medium for the light arranged between the object surface and the body,
where n₂(λ) is the refractive index, generally dependent on the wave sounds λ, of the body for the light,
wherein n₃(λ) is the refractive index, generally dependent on the wave sounds λ, of an optical medium for the light arranged between the pupil and the body,
wherein the diffraction structure has for the light incident on a side of the spectacle lens facing away from the observer with respect to the surface normal at the angle of incidence α₁ to the surface normal of the spectacle lens front surface from the point on the object surface a diffractive dispersion D_{diff.1} that compensates at least partially for the refractive dispersion D_{ref.}:=D_{ref.1}+D_{ref.2} of the body with
$${D}_{diff .1} := \frac{\partial {α}_{4}}{\partial λ} = \frac{m}{{Λ}_{proj .38} cos {α}_{4}} ,$$
wherein α₄ is a deflection angle, related to a surface normal at a place of the body surface on which the diffraction structure is made to extend that is passed through by the light incident on the spectacle lens front surface at the angle of incidence α₁ to the surface normal of the spectacle lens front surface from the point on the object surface, for the light incident on the spectacle lens front surface at the angle of incidence α₁ to the surface normal of the spectacle lens front surface from the point on the object surface,
wherein the diffraction structure is a hologram of at least a first reference wave W₁₁ and a second reference wave W₁₂, which is formed as an optical grating that has a local grating period vector
\vec{Λ_{G38}}:=Λ₃₈ₓ\vec{eₓ}+Λ_{38y}\vec{e_{y}}+Λ_{38z}\vec{e_{z}}
and a local grating vector
$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$
with a grating vector amount
$$\vert \vec{{k}_{G 38}} \vert := \vert \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}} \vert ,$$
and
wherein _{Aproj.38} is the grating period of the projection of the grating vector
$$\vec{{k}_{G 38}} := \frac{2 π}{{Λ}_{38 x}} \vec{{e}_{x}} + \frac{2 π}{{Λ}_{38 y}} \vec{{e}_{y}} + \frac{2 π}{{Λ}_{38 z}} \vec{{e}_{z}}$$
onto the body surface with
$${Λ}_{proj .38} := \frac{2 π}{\vert \frac{2 π}{{Λ}_{38 x}} \vec{{e}_{x}} + \frac{2 π}{{Λ}_{38 y}} \vec{{e}_{y}} \vert} .$$

42. The spectacle lens as claimed in claim 41, wherein the following applies:
sign(D_{ref.1}+D_{ref.2})=−sign(D_{diff.1}).

43. The spectacle lens as claimed in claim 41, wherein at least one further diffraction structure, which diffracts light diffracted into a first order of diffraction O1 by the at least one diffraction structure into an order of diffraction O2, for which the following applies |O1|=|O2| and sign(O1)=sign(O2),
wherein the at least one further diffraction structure is made to extend on a further body surface, which may coincide with the first body surface and is formed by a spatial modulation of the refractive index n(x, y) dependent on the location in the body surface,
wherein the at least one further diffraction structure is a hologram of at least one further first reference wave W₂₁ and a further second reference wave W₂₂, wherein the further first reference wave W₂₁ is the first reference wave W₁₁ diffracted by the at least one diffraction structure or the second reference wave W₁₂ diffracted by the at least one diffraction structure,
wherein the hologram of the further diffraction structure is formed as a further optical grating that has a local grating period vector
\vec{Λ_{G40}}:=Λ₄₀ₓ\vec{eₓ}+Λ_{40y}\vec{e_{y}}+Λ_{40z}\vec{e_{z}}
and a local grating vector
$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$
with a grating vector amount
$$\vert \vec{{k}_{G 40}} \vert := \vert \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}} \vert$$
wherein, for the light incident on a side of the spectacle lens facing away from the observer with respect to the surface normal at the angle of incidence α₁ to the surface normal of the spectacle lens front surface from the point on the object surface and then refracted to the angle α₂ with respect to the surface normal, the at least one further diffraction structure has a diffractive dispersion D_{diff.2} with
$${D}_{diff .2} := \frac{\partial {α}_{3}}{\partial λ} = \frac{m}{{Λ}_{proj .40} cos {α}_{3}} ,$$
wherein Λ_{proj.40} is the grating period of the projection of the grating vector of the further optical grating
$$\vec{{k}_{G 40}} := \frac{2 π}{{Λ}_{40 x}} \vec{{e}_{x}} + \frac{2 π}{{Λ}_{40 y}} \vec{{e}_{y}} + \frac{2 π}{{Λ}_{40 z}} \vec{{e}_{z}}$$
onto the further body surface with
$${Λ}_{proj .40} := \frac{2 π}{\vert \frac{2 π}{{Λ}_{40 x}} \vec{{e}_{x}} + \frac{2 π}{{Λ}_{40 y}} \vec{{e}_{y}} \vert}$$
and wherein α₃ is a deflection angle, related to a surface normal at a place of the further body surface on which the further diffraction structure is made to extend that is passed through by the light incident on the spectacle lens front surface at the angle of incidence α₁ to the surface normal of the spectacle lens front surface from the point on the object surface, for the light incident on the spectacle lens front surface at the angle of incidence α₁ to the surface normal of the spectacle lens front surface from the point on the object surface.

44. The spectacle lens as claimed in claim 43, wherein the following applies:
sign(D_{ref.1}+D_{ref.2})=−sign(D_{diff.1}+D_{diff.2})

45. The spectacle lens as claimed in claim 44, wherein the following applies:

|D_{ref.1}+D_{ref.1}+D_{diff.1}+D_{diff.1}|≤S,
with S=0.72 cm/m.

46. The spectacle lens as claimed in claim 45, wherein the grating vector \vec{k_{G38}} of the diffraction structure and the grating vector \vec{k_{G40}} of the further diffraction structure have for at least one viewing direction of the observer grating vector amounts |\vec{k_{G38}}|, |\vec{k_{G40}}| that optimize a cost function K, wherein the cost function K contains a cost function term Kᵢ with:
Kᵢ:=K_{iGP1}+K_{iGP2}+K_{iGP2}+K_{iSPH}+K_{iFF}
with
$${K}_{iGP 1} := {a}_{1} ( \vert \frac{2 π}{\vert \vec{{k}_{G 38}} \vert} - 2.4 µm \vert - 0.4 µm )$$
at the location passed through by the viewing direction on the body surface on which the diffraction structure is made to extend,
with
$${K}_{iGP 2} := {a}_{2} ( \vert \frac{2 π}{\vert \vec{{k}_{G 40}} \vert} - 2.4 µm \vert - 0.4 µm )$$
at the location passed through by the viewing direction on the further body surface on which the further diffraction structure is made to extend,
with K_{ISP}:=a₃(SPHᵢₛₜ−SPHₛₒₗₗ) as a spherical imaging aberration of the point on the object surface,
with K_{SAT}:=a₄(ASTᵢₛₜ−ASTₛₒₗₗ) as an imaging astigmatic aberration of the point on the object surface,
with K_{iFF}=a₅(FFᵢₛₜ−FFₛₒₗₗ) as an imaging chromatic aberration of the point on the object surface,
wherein the coefficients aₓ is freely selected with x=1, 2, 3, 4, 5.

47. The spectacle lens as claimed in claim 45, wherein the grating vector \vec{k_{G38}} of the diffraction structure and the grating vector \vec{k_{G40}} of the further diffraction structure have for a large number of viewing directions i of the observer grating vector amounts |\vec{k_{G38}}|, |\vec{k_{G40}}| that optimize a cost function K, wherein the cost function K contains a cost function term \tilde{K}: with
$$\tilde{K} := {\sum }_{i} Ki$$
wherein
Kᵢ:=K_{iGP1}+K_{iGP2}+K_{iGP2}+K_{iSPH}+K_{iFF}
with
$${K}_{iGP 1} := {a}_{1} ( \vert \frac{2 π}{\vert \vec{{k}_{G 38}} \vert} - 2.4 µm \vert - 0.4 µm )$$
at the location passed through by the viewing direction i on the body surface on which the diffraction structure is made to extend,
with
$${K}_{iGP 2} := {a}_{2} ( \vert \frac{2 π}{\vert \vec{{k}_{G 40}} \vert} - 2.4 µm \vert - 0.4 µm )$$
at the location passed through by the viewing direction i on the further body surface on which the further diffraction structure is made to extend,
with K_{iSPH}:=aᵢ₃(SPHᵢₛₜ−SPHₛₒₗₗ) as a spherical imaging aberration of the point on the object surface,
with K_{SAT}:=aᵢ₄(ASTᵢₛₜ−ASTₛₒₗₗ) as an astigmatic imaging aberration of the point on the object surface,
with K_{iFF}=aᵢ₅(FFᵢₛₜ−FFₛₒₗₗ) as a chromatic imaging aberration of the point on the object surface,
wherein the coefficients aᵢₓ are freely selected with x=1, 2, 3, 4, 5.

48. The spectacle lens as claimed in claim 47, wherein a geometry of the body has values that optimize the cost function K.

49. The spectacle lens as claimed in claim 48, wherein the geometry of the body has coefficients describing an aspherical shape or a free-surface shape of at least one of the spectacle lens front surface or the spectacle lens rear surface.

50. A method for determining the design of a spectacle lens with a body, the method comprising:
specifying a geometry and an object surface from the group including a free-form surface, a plane, a curved surface, or a bent surface, the object surface being arranged on a side of the spectacle lens facing away from the observer;
specifying an optical transfer function for the spectacle lens;
calculating a phase object which directs the light incident on a side of the spectacle lens facing away from the observer at an angle of incidence α to a surface normal \vec{n} of the of the spectacle lens front surface in a direction dependent on the wavelength λ of the light and on the angle of incidence α of the light for the specified optical transfer function and the specified geometry,
wherein the phase object contains at least one diffraction structure, which is made to extend in the body on a body surface and, when observing an object surface, can be passed through by a line of sight ray that corresponds to a viewing direction of an eye of the observer having a center of rotation of the eye and a pupil center and extends through the center of rotation of the eye and the pupil center as well as the point on the object surface;
forming the at least one diffraction structure by a spatial modulation of the refractive index n(x, y) that is dependent on the location (x, y) in the body surface passed through by the viewing direction,
wherein the spatial modulation of the refractive index n(x, y) in the body is continuous and the diffraction structure converts a spherical light wave which originates from a point on an object surface into a light wave which projects an image of the point on the object surface onto an image point lying in an image surface that is optically conjugate to the object surface,
wherein the diffraction structure converts a spherical light wave which originates from a point on the object surface that is passed through by the viewing direction into a light wave, running along the viewing direction, which projects an image of the point on the object surface onto an image point in the eye of the observer lying in an image surface that is optically conjugate to the object surface,
wherein the spatial modulation of the refractive index n(x, y) is continuous over a contiguous area B of the body surface, for the diameter D of which, defined as the supremum of the metric distance d(x,y) between two arbitrary points x, y arranged in the area of the body surface, with
D:=sup{d(x, y): x, y ∈ B},
the following applies:
D≥10 mm
or
D≥20 mm,
and wherein the diffraction structure in the area B converts a spherical light wave which originates from a point on an object surface into a light wave which projects an image of the point on the object surface onto an image point lying in an image surface that is optically conjugate to the object surface.

51. A method for producing a spectacle lens as claimed in claim 35, the method comprising:
generating a phase object which contains at least one hologram of a first reference wave W₁₁ with a light modulator and a second reference wave W₁₂ with the light modulator or providing a computer-generated hologram.

52. The method as claimed in claim 51 further comprising:
generating the phase object by exposing a film which is cemented to a glass body or a glass substrate.

53. The spectacle lens as claimed in claim 52, wherein at least one of a center thickness of the body, a front radius of the body, or a back radius of the body has values that optimize the cost function K
